(19) United States
(12) Patent Application Publication
(10) Pub. No.: US 2025/0363462 A1
(43) Pub. Date: Nov. 27, 2025

(54) ACTIVITY NOTIFICATIONS OF USERS HAVING CUSTOMIZED CALENDARS WITH SHORTENED ATTENDANCE PERIODS

(71) Applicant: Microsoft Technology Licensing, LLC, Redmond, WA (US)

(72) Inventors: Amer Aref HASSAN, Kirkland, WA (US); Eric Edmond THOMASIAN, Los Angeles, CA (US); Zhen ZHU, Coquitlam (CA)

(21) Appl. No.: 18/673,758

(22) Filed: May 24, 2024

(51) Int. Cl. G06Q 10/1093; G06F 9/451

(52) U.S. Cl. CPC G06Q 10/1093; G06F 9/451

(57) ABSTRACT

The techniques disclosed herein provide enhanced notifications indicating activity of a user having a customized calendar having shortened attendance periods. In some embodiments, a system displays a new user interface (UI) allowing a user, like a corporate executive, to identify through a UI selection or an automated calendar function that the user attends only a limited duration of a meeting. In response, the system generates another UI during the partially accepted meetings to display an indicator next to the user's icon indicating how soon the user will be arriving or leaving the meeting. This UI is displayed to other attendees of the meeting other than the user having the shortened attendance schedule.

### BACKGROUND

There are a number of different types of collaborative systems that allow users to communicate. For example, some systems allow people to collaborate by sharing content using video and audio streams, shared files, chat messages, etc. Some systems manage communication sessions, which are also referred to herein as online meetings, virtual reality sessions, broadcasts, etc. Some communication sessions, which are also referred to as events or meetings, have a distinct start time and an end time that occur on specific dates. People can schedule these sessions on a calendar and have a number of events scheduled throughout the day. Users can schedule meetings in advance, invite other participants, and use various features such as audio, video, chat, screen sharing, whiteboards, etc.

Although some systems can provide a number of features that allow people to collaborate during specific events, such systems have a number of drawbacks. For example, some people may have a number of events scheduled for the same timeslot. This can lead to a scenario where some people are left to grapple with the challenge of managing multiple overlapping meetings throughout their day. This scheduling conundrum not only strains their capacity to allocate time effectively but also places a significant burden on others who manage their calendar. Existing systems leave such users with the daunting task of juggling conflicting appointments, and the challenges of prioritizing and rearranging meetings in a way that allows a person with a crowded calendar to attend the most critical meetings or the most critical parts of meetings. This issue is particularly challenging for those who have three or more meeting requests for each timeslot throughout the day. This situation renders existing calendar programs to be relatively useless. A person is left with the option of accepting all meetings and then manually juggling their schedule within each time slot without any scheduling tools that operate in the time increments or coordination that is needed. The complexity of aligning stakeholders' schedules, addressing urgent needs, and ensuring that people can maximize their presence in meetings, highlights a significant issue in the realm of time management programs.

In another example, existing communication applications do not properly provide notifications when users only attend portions of meetings. Often times, when meeting participants only attend a portion of a meeting, other participants are often not aware of their presence. In addition, there are no effective mechanisms that provide notifications when late users are going to arrive or when users leave a meeting early. These above-described situations often lead to reduced productivity and inefficient use of computing resources, underscoring the need for more efficient scheduling solutions.

### SUMMARY

The techniques disclosed herein provide enhanced notifications indicating activity of a user having a customized calendar having shortened attendance periods. In some embodiments, a system displays a new user interface (UI) allowing a user, like a corporate executive, to identify through a UI selection or an automated calendar function that the user attends only a limited duration of a meeting. In response, the system generates another UI during the partially accepted meetings to display an indicator next to the user's icon indicating how soon the user will be arriving or leaving the meeting. This UI is displayed to other attendees of the meeting other than the user having the shortened attendance schedule.

The system allows a user to accept attendance for a portion of a meeting. A secondary calendar stores the start time and end time of which the user is scheduled to attend only a portion of the meeting. In some embodiments, a system displays a new user interface (UI) to create a customized secondary calendar according to meeting objects from a primary calendar. The user can select shortened attendance periods for each meeting that is included in their primary calendar. Data defining the shortened attendance periods for each meeting can be stored in a secondary calendar. The system can also use an AI model to determine which meeting portions the user will attend. In response to the creation of the secondary calendar, the system sends RSVP data to bulk update meeting objects accessible by attendees. In one embodiment, the secondary calendar allows user to arrange meetings in shorter durations compared to the respective meeting durations in the primary calendar. Then, during each meeting, notifications are shared with other meeting attendees, where the notifications show when the user with the shortened attendance schedule is joining a meeting or leaving a meeting.

For example, if a user has three meetings on their primary calendar all within the same hour, that user can utilize the UI to partially accept all three meetings where they attend the first meeting for the first 20 minutes of the hour, the second meeting for the second 20 minutes of the hour, and the third meeting for the third 20 minutes of the hour. The system generates secondary meetings for each of the 20-minute allocations and stores those secondary meetings in a secondary calendar. The system can then use the primary calendar and the secondary calendar to notify the participants of the three meetings listed in the primary calendar of the user's partial acceptance of each meeting. As each meeting progresses, other users can see when the user will join the first meeting, when the user will leave the first meeting, when the user will join the second meeting, when the user will leave the second meeting, etc.

The system can also automatically control permissions during the transitions between meeting portions using the primary calendar and the secondary calendar. For example, a user may have access to a first set of files shared in a first 1-hour meeting for a first 20-minute block of time of that person's attendance that is defined in the secondary calendar, then the user may have access to a second set of files shared in a second 1-hour meeting that is currently scheduled with the first 1-hour meeting for a second 20-minute block of time of that person's attendance that is defined in the secondary calendar. Using the secondary calendar to control permissions of content in each 1-hour meeting enables the system to maintain a high level of integrity for the primary calendar defining each 1-hour meeting, while also using the secondary calendar to give the system improved security of data by having more granular control to change permissions of files during shorter periods of time.

The technical challenge of overlapping calendar of events is addressed by the technical solution of providing enhanced controls for configurating calendar event partitions and enhanced notifications indicating user activity for partitioned calendar events. The system also provides improved user interaction by providing notifications for these partitioned calendar events. Thus, in addition to improving the security of a system, the techniques disclosed herein can provide a number of improved efficiencies. By providing automated transitions for shorter periods of time, meeting participants can move between meetings and spend less time controlling permissions and meeting controls and focus on salient points with minimal interruptions. When information and transitions are organized more accurately and with fewer manual inputs, audience members are less likely to miss salient information during an event. Such benefits can increase the efficiency of a computing system by reducing the number of times a user needs to interact with a computing device to obtain information, e.g., prolonging meetings, retrieving meeting recordings, requesting duplicate copies of previously shared content, etc. Thus, various computing resources such as network resources, memory resources, and processing resources can be reduced.

The techniques disclosed herein also provide improved summarization of information for meetings. By using a primary calendar and a secondary calendar to notify the participants of the three meetings listed in the primary calendar of the user's partial acceptance of each meeting, and doing so in a bulk update, the disclosed system presents information to users that allows better and more efficient interactions for small-screen devices. Also, during each meeting, the system guides the user through each portion of each meeting, e.g., when to leave a first meeting to join the second meeting, etc. This is particularly helpful in small-screen devices and other devices in that the users are directed by a system using a particular manner of summarizing and presenting information in electronic devices.

The techniques disclosed herein also provide a system with more automated controls when transitioning a person between shorter meetings and aligning permissions to specific roles of an event. Such features can also lead to a more desirable user experience. In particular, by automatically transitioning a person between shorter meetings, a system can reduce the number of times a user needs to interact with a computing device to control roles and security permissions. This can lead to the reduction of manual data entry that needs to be performed by a user. By reducing the need for manual entry, inadvertent inputs and human error can be reduced. This can ultimately lead to a reduction in undesirable permissions and more efficient use of computing resources such as memory usage, network usage, processing resources, etc.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a system providing controls for configurating secondary calendars and enhanced notifications indicating user activity for partitioned calendar events.

FIG. 2A shows a phase of a process for configurating secondary calendars where a system is in regular calendar viewing mode.

FIG. 2B shows a phase of a process for configurating secondary calendars where a system enters a special calendar edit mode where a communication application has limited rights to edit a primary calendar and stores event partitions in a secondary calendar.

FIG. 2C shows a phase of a process for configurating secondary calendars where a user selects a primary meeting of a primary calendar and associates that meeting with a time slot of a secondary meeting of a secondary calendar.

FIG. 2D shows a phase of a process for configurating secondary calendars where the system stores the time slot of a secondary meeting in a secondary calendar.

FIG. 2E shows a phase of a process for configurating secondary calendars where a user selects another primary meeting of a primary calendar and associates that meeting with another time slot of another secondary meeting of a secondary calendar.

FIG. 2F shows a phase of a process for configurating secondary calendars where the system stores the other time slot of the other secondary meeting in a secondary calendar.

FIG. 2G shows a phase of a process for configurating secondary calendars where the system modifies one of the time slots of the secondary calendar.

FIG. 2H shows a phase of a process for configurating secondary calendars where a user selects additional primary meetings of a primary calendar and associates those meetings with additional time slots of additional secondary meetings of a secondary calendar.

FIG. 3A shows a phase of a process for sending bulk RSVPs, where a user accepts the configuration of a secondary calendar that is built using objects of a primary calendar.

FIG. 3B shows a phase of a process for sending bulk RSVPs, where in response to a user accepting the configuration of a secondary calendar that is built using objects of a primary calendar, the system generates RSVP data to send to each meeting attendee of the meetings of the primary calendar.

FIG. 4A shows a phase of a process for configurating secondary calendars where a communication application of a system is in standard calendar mode calendar.

FIG. 4B shows a phase of a process for configurating secondary calendars where the system transitions to conflict mode to display a conflict menu having a first template defining time slots of a secondary calendar and a control for showing a second template.

FIG. 4C shows a phase of a process for configurating secondary calendars where the system receives an input selecting a second template.

FIG. 4D shows a phase of a process for configurating secondary calendars where the system displays a second template defining a second set of time slots of the secondary calendar.

FIG. 5A shows a phase of a process for using secondary calendars of a secondary calendar where the system generates notifications showing a person when to leave a first meeting to join the second meeting, this phase showing a time that does not meet a threshold.

FIG. 5B shows a phase of a process for using secondary calendars of a secondary calendar where the system generates notifications showing a person when to leave a first meeting to join the second meeting, this phase showing a time that meets a threshold and a notification is displayed.

FIG. 5C shows a phase of a process for using secondary calendars of a secondary calendar where the system generates notifications showing a person when to leave a first meeting to join the second meeting, this phase showing a time that meets a threshold and a notification is displayed showing a countdown to a leave time.

FIG. 5D shows a phase of a process for using secondary calendars of a secondary calendar where the system generates notifications showing the owner of the secondary calendar when to leave a first meeting to join the second meeting, this phase showing a time that meets a threshold and a notification is displayed showing a specific time to leave.

FIG. 6A shows a phase of a process for generating notifications indicating activity of a user having a customized calendar for attending a portion of a meeting of a primary calendar, this phase showing a time that meets a threshold and a notification is displayed showing a specific time of when a user is to arrive at a meeting.

FIG. 6B shows a phase of a process for generating notifications indicating activity of a user having a customized calendar for attending a portion of a meeting of a primary calendar, this phase showing a time that meets a threshold and a notification is displayed showing that a user has arrived at a meeting.

FIG. 6C shows a phase of a process for generating notifications indicating activity of a user having a customized calendar, this phase showing a time that meets a threshold and a notification is displayed showing a time when a user is to leave a meeting.

FIG. 6D shows a phase of a process for generating notifications indicating activity of a user having a customized calendar, this phase showing a time that meets a threshold and a notification is displayed showing a countdown to a time when a user is to leave a meeting.

FIG. 6E shows a phase of a process for generating notifications indicating activity of a user having a customized calendar, this phase showing a time that meets a threshold and a notification is displayed showing that a user is leaving a meeting.

FIG. 6F shows a phase of a process for generating notifications indicating activity of a user having a customized calendar, this phase showing a time that meets a threshold and a notification is displayed showing a time when a user left a meeting.

FIG. 7A shows a phase of a process for generating notifications indicating activity of a user having a customized calendar for attending a portion of a meeting of a primary calendar, this phase showing a time that meets a threshold and a notification is displayed showing a specific time of when a user is to arrive at the meeting.

FIG. 7B shows a phase of a process for generating notifications indicating activity of a user having a customized calendar for attending a portion of a meeting of a primary calendar, this phase showing a time that meets a threshold and a notification is displayed showing a countdown time of when a user is to arrive at the meeting.

FIG. 7C shows a phase of a process for generating notifications indicating activity of a user having a customized calendar for attending a portion of a meeting of a primary calendar, this phase showing a time that meets a threshold and a notification is displayed showing that a user has arrived at a meeting and is showing an active video stream.

FIG. 7D shows a phase of a process for generating notifications indicating activity of a user having a customized calendar, this phase showing a time that meets a threshold and a notification is displayed showing a time when a user is to leave a meeting, while also showing a rendering of that user in a video display region.

FIG. 7E shows a phase of a process for generating notifications indicating activity of a user having a customized calendar, this phase showing a time that meets a threshold and a notification is displayed showing a countdown to a time when a user is to leave a meeting.

FIG. 7F shows a phase of a process for generating notifications indicating activity of a user having a customized calendar, this phase showing a time that meets a threshold and a notification is displayed showing that a user has left a meeting.

FIG. 8 shows a user interface arrangement having an overlay view of the partial meeting attendance periods for a user that is positioned over that person's primary calendar to show how the primary calendar events and the secondary calendar events are related.

FIG. 9 shows a block diagram of a system that utilizes a large language model to determine the parameters of a calendar template and attendance periods for a user's secondary calendar.

FIG. 10 is a flow diagram showing aspects of a routine for providing controls for configurating secondary calendars and enhanced notifications indicating user activity for partitioned calendar events.

FIG. 11 is a diagram illustrating a distributed computing environment capable of implementing aspects of the techniques and technologies presented herein.

FIG. 12 is a computer architecture diagram illustrating a computing device architecture for a computing device capable of implementing aspects of the techniques and technologies presented herein.

### DETAILED DESCRIPTION

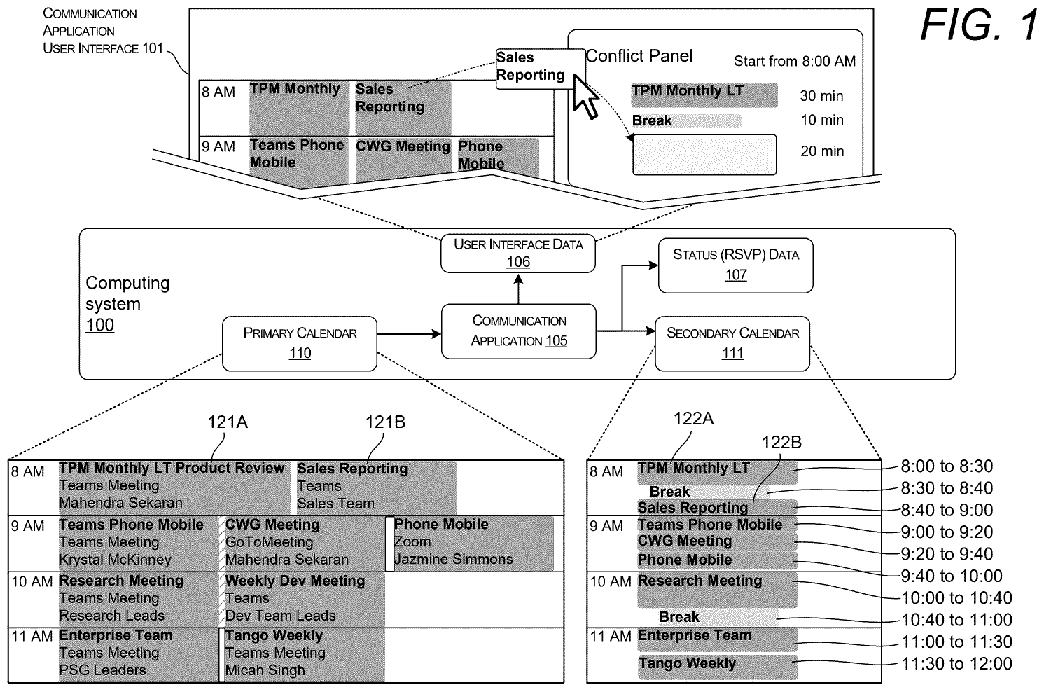

FIG. 1 shows a system 100 for providing enhanced controls for configurating customized calendar events having shortened attendance periods for a user. The system 100 displays a UI 101 configured to receive an input to select a primary meeting object 121A, also referred to herein as a primary calendar event 121A or a primary meeting 121A. The user input associates the primary meeting object with a secondary meeting object 122A. The input also provides an indication of a duration of attendance for the user for the selected primary meeting 122A. In this example, the user has selected the TPM meeting in the user's primary calendar and associates that primary meeting with the time slot of a secondary meeting defined in a template. This input indicates that the user is going to attend the TPM meeting for 20 minutes even though the primary meeting is scheduled for one hour. The input also provides an indication of a start time and an end time of the attendance for the user.

The secondary calendar stores data that indicates that the user has accepted invitations to meetings defined in their primary calendar, and those accepted invitations indicate that the use is to attend meetings with shorter durations compared to the duration of respective meetings defined in the primary calendar. The system uses the primary calendar and the secondary calendar to generate status RSVP data 107 to notify the participants of the primary meetings listed in the primary calendar of the user's partial acceptance of each meeting. Also, during each meeting, the system guides the user during their shortened attendance period with notifications indicating when to leave a meeting or when to join another meeting.

The primary calendar and the secondary calendar are both accessed by a communication application 105, such as MS TEAMS, GOOGLE MEET, or other communication programs by Meta, Zoom, or Slack. The primary calendar can also be managed by a calendaring application such as MS OUTLOOK, GOOGLE CALENDAR, etc. A calendaring application can be used to generate meetings and invite other users to those meetings. The calendaring application can also be used to access the secondary calendar to determine if a user has sent an RSVP with a shortened attendance period in response to a meeting invitation. The system is configured with permissions that restrict the calendaring application from editing the secondary calendar. In some embodiments, the system permissions only allow the communication application to edit the secondary calendar.

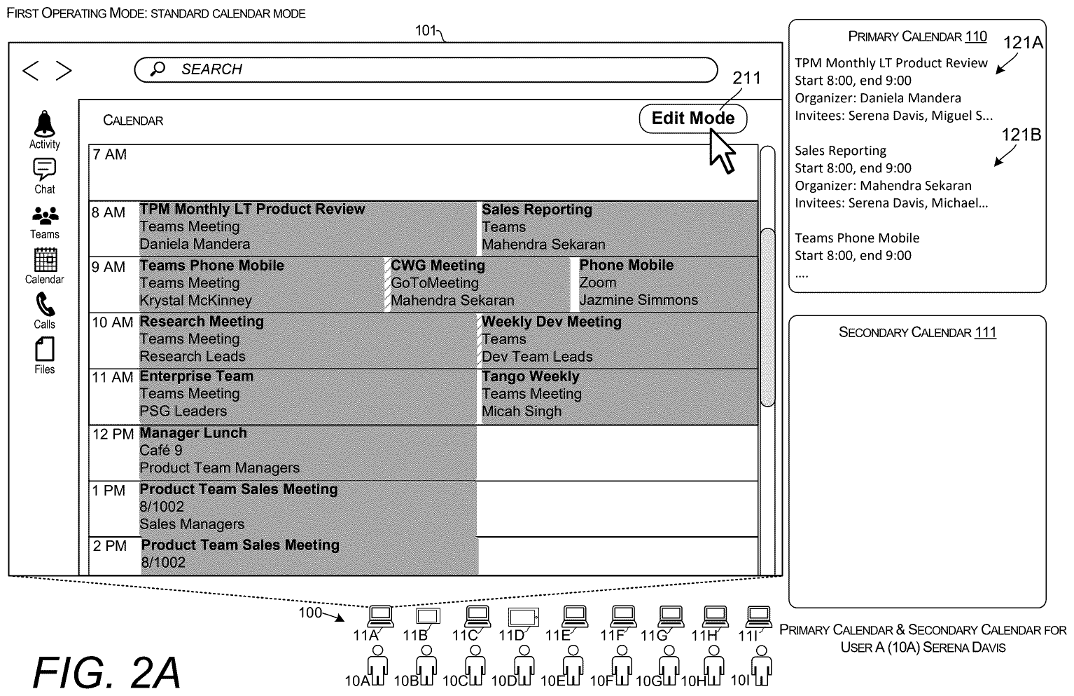

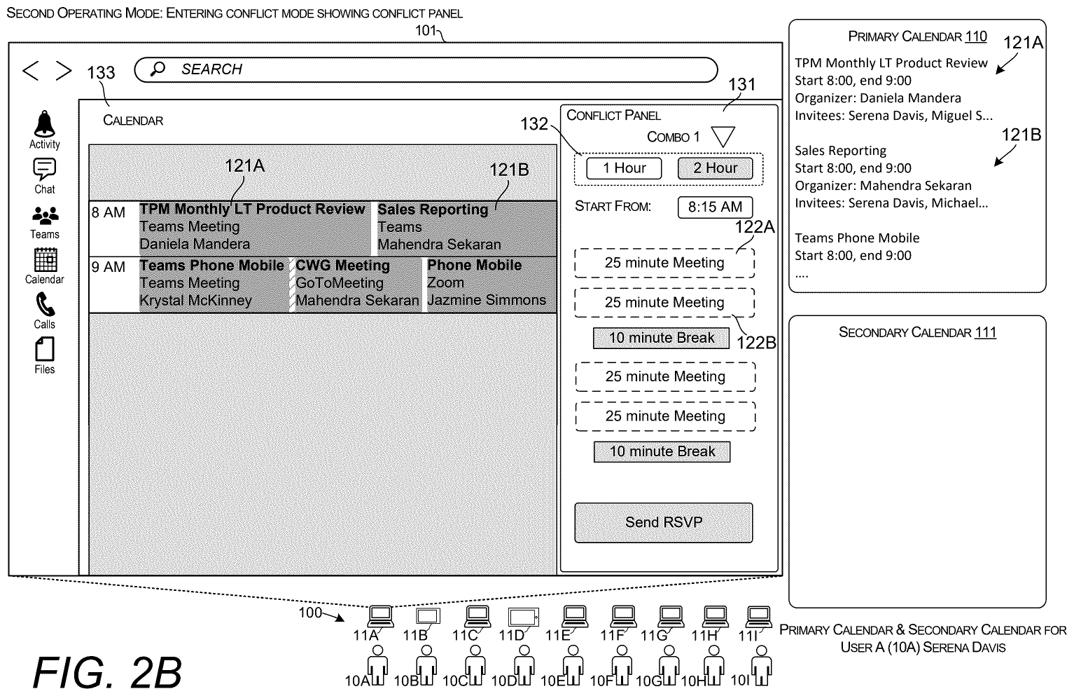

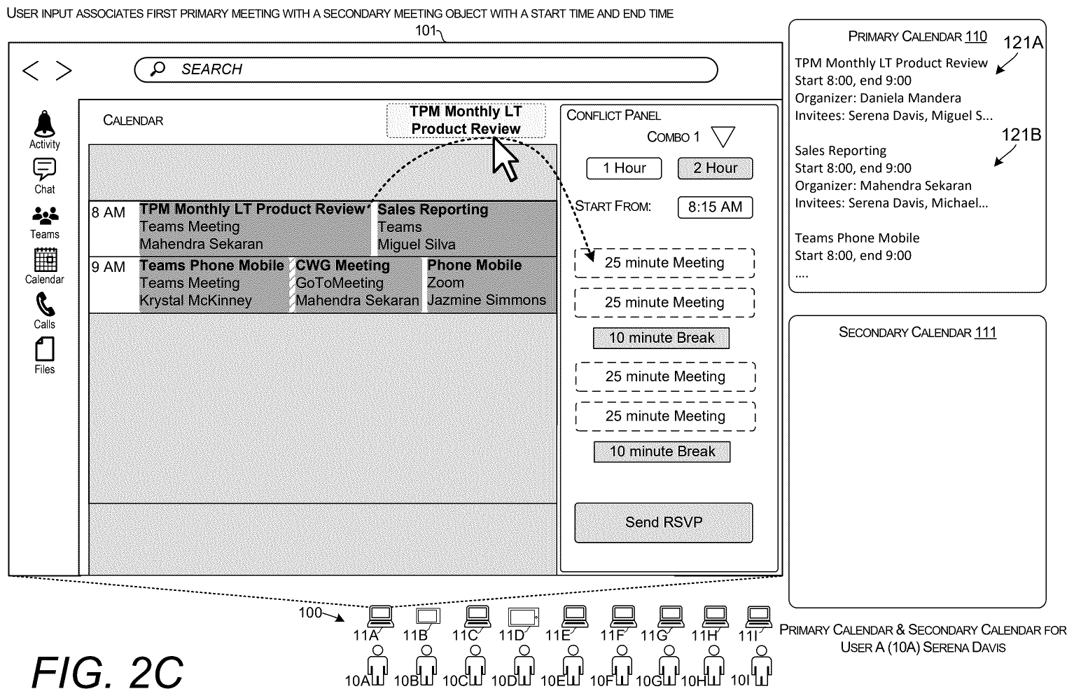

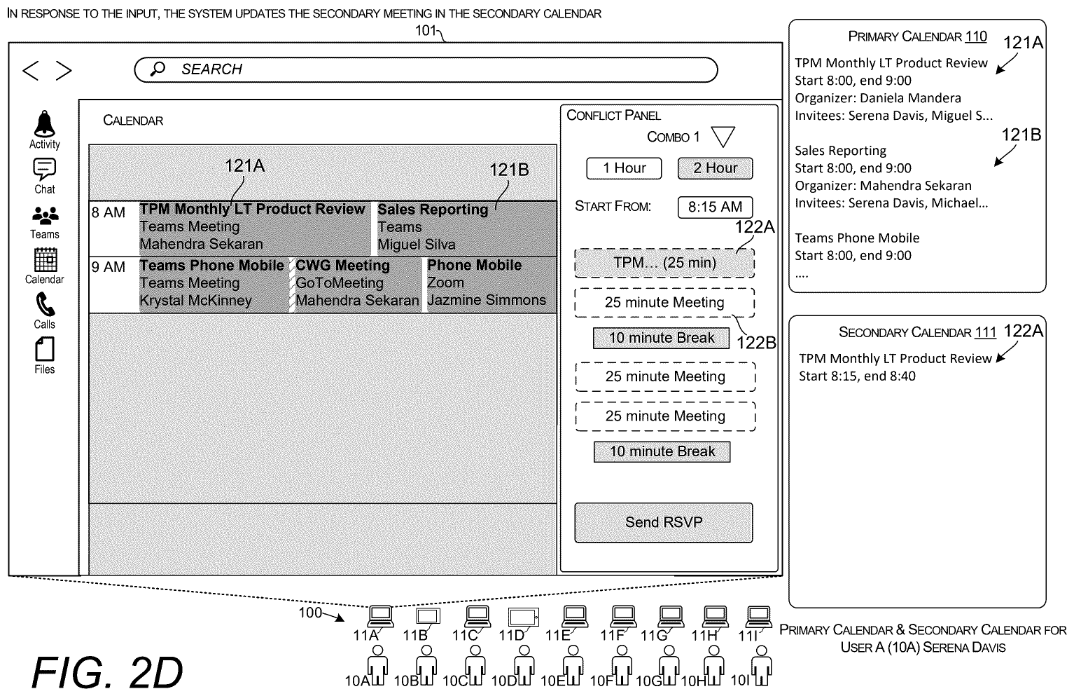

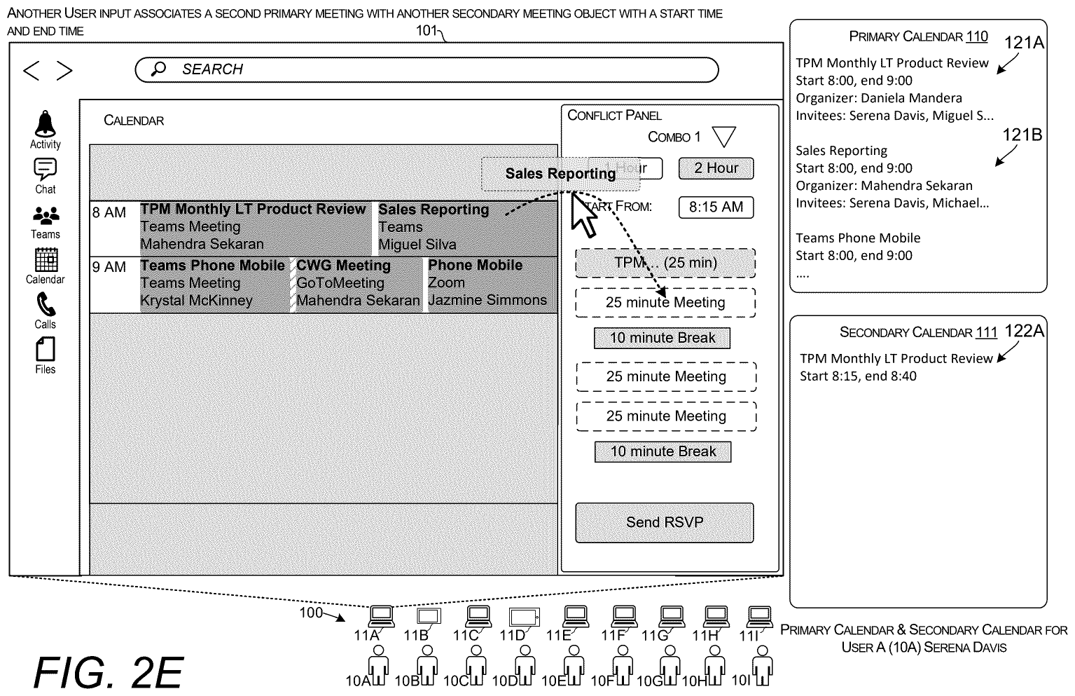

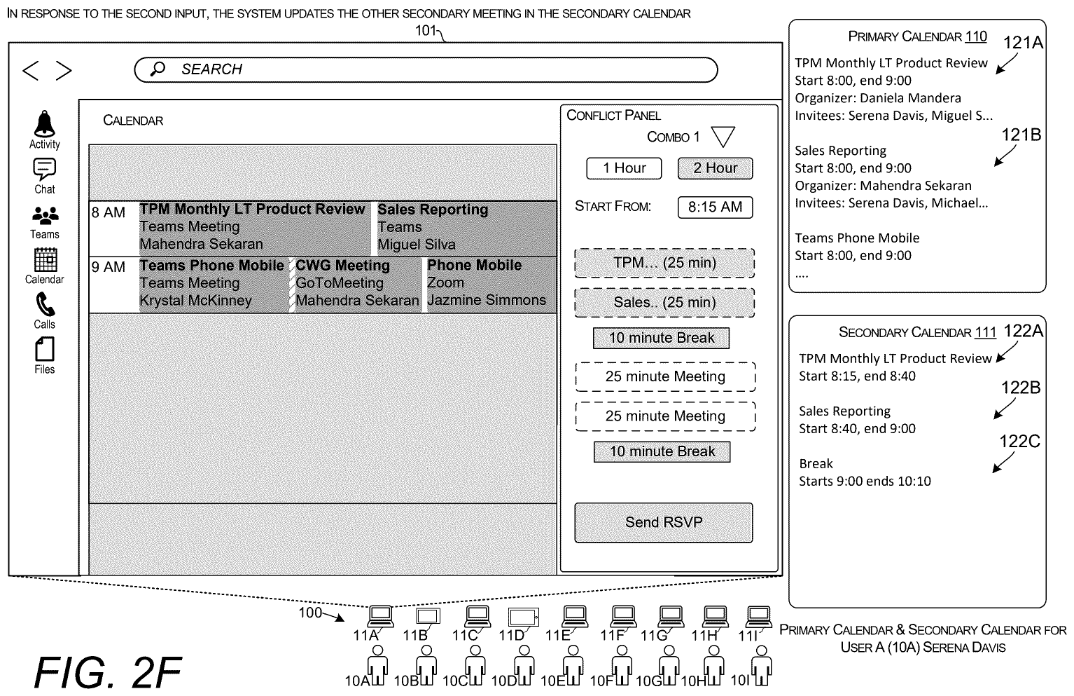

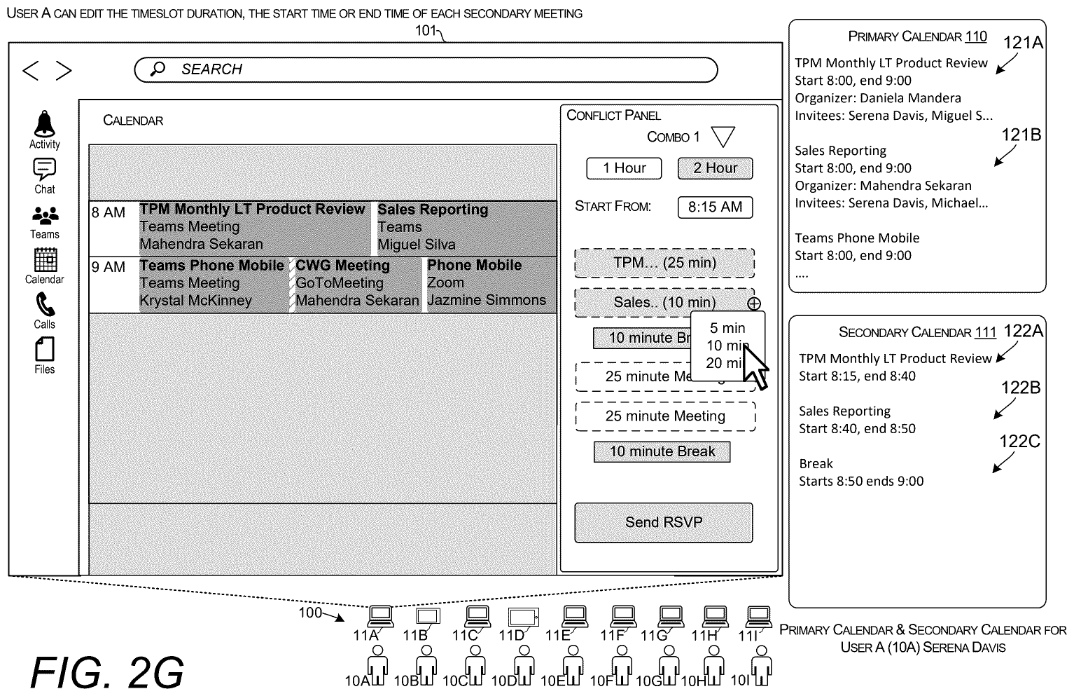

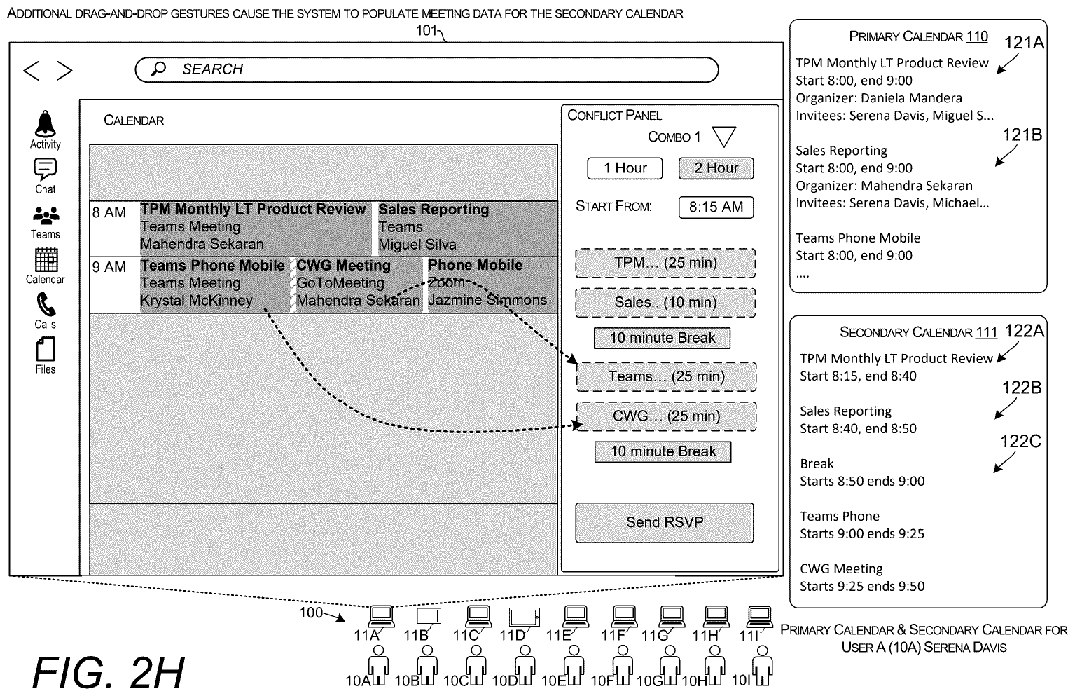

FIGS. 2A-2H illustrate a system 100 that provides enhanced controls for configurating customized calendar events. As shown in FIG. 2A, the system 100 includes a number of computing devices 11 each associated with a user 10. The computers are each interconnected using a communication session for sharing video signals, audio signals, and other shared content such as documents. In this example, there are a number of users (10A-10H) in a meeting, where User A 10A, Serena Davis, is associated with a first computing device 11A, User B 10B, Miguel Silva, is associated with a second computing device 11B, User C 10C, Krystal McKinney, is associated with a third computing device 11C, User D 10D, Jazmine Simmons, is associated with a fourth computing device 11D, User E, Mahendra Sekaran, is associated with a fifth computing device 11E, User F 10F, Michael Wong, is associated with a sixth computing device 11F, User G 10G, Will Newman, is associated with a seventh computing device 11G, User H 10H, Cassie Price, is associated with an eighth computing device 11H, and User I 10I, Daniela Mandera, is associated with a ninth computing device 11I. The device of each user is configured to participate in a communication session, e.g., a meeting, at times configured according to a primary calendar, while allowing select users to participate in portions of each communication session according to a secondary calendar. Each communication session can have a unique set of participants as defined by the primary calendar.

In the examples below, one primary meeting, the TPM meeting, includes Daniela Mandera, User I 10I, as the organizer with other attendees Users A-D who accepted Daniela's invitation. User A has accepted the invitation for this meeting with a shortened schedule as described in more detail below. Another primary meeting, the Sales meeting, includes Mahendra Sekaran, User E 10E, as the organizer with other attendees User A and Users F-H who accepted Daniela's invitation. User A has accepted the invitation for this meeting with a shortened schedule as described in more detail below.

FIGS. 2A-2H also show a process for generating a UI 101 for customizing secondary calendar according to meeting objects from a primary calendar. Also shown, the system also includes backend data structures and operations for managing meeting objects in primary calendar and secondary calendar. FIG. 2A shows a UI 101 that is configured to manage a customized schedule for a user 10A to attend a first meeting 121A defined by a primary calendar 110. This first meeting (“TPM meeting”) is scheduled for an hour starting at 8 o′clock. The other meetings are also scheduled for one hour blocks of time, as shown.

In FIG. 2A, the system is in a standard calendar mode where the primary calendar is displayed within a communication program, where the user can view and edit the primary calendar. The system is also configured to receive an input to change the operating mode of the device from the standard calendar mode to a conflict mode. In one embodiment, the UI 101 is configured to receive an input at a control element 211 to change the system to the conflict mode. In general, conflict mode is invoked when a user wants to accept an invitation to any portion of the meetings in the primary calendar using a shortened schedule. As described in more detail below, if the user wishes to attend a portion of a meeting, e.g., a meeting partition, The user can invoke the conflict mode and select a primary meeting from the primary calendar and also select a shortened attendance period for that meeting. The data defining the shorten attendance period is stored in a separate data structure, the secondary calendar 111.

FIG. 2B shows the device 11A of User A in conflict mode. In this mode of operation, the system generates a UI 101 that provides a new way to create a customized secondary calendar that corresponds to meeting objects from a primary calendar. In some embodiments, the system causes a display of a user interface 101 comprising a number of primary meeting objects 121 retrieved from a primary calendar 110. The user interface 101 also includes control elements for selecting a primary meeting object 121A for causing the system to generate a secondary meeting object 122A. The control elements can include a configuration where the system can receive an input, such as a gesture or voice command, to associate a primary meeting 121 with a time slot.

In this example, the time slots can be provided in a template displayed in a conflict panel 131. The conflict panel 131 can include a first set of controls 132 that allows a user to filter the primary meetings that are displayed and the primary calendar region 133. The filter allows the user to select a time period of interest, such as a 2 hour window. The UI also allows the user to select a start time for the filter. In this example, the filter start time can be entered using a text entry field or a drop down menu. In this particular example, the user has elected to view primary calendar items starting from 8:15 with a 2 hour window. In response, the calendar region only shows items between 8:00 and 10:00 AM.

In some embodiments, the UI includes a template having a graphical element representing the start time of each secondary meeting object and the end time of each secondary meeting object. The UI can include features for receiving an input that includes a drag-and-drop input gesture of moving a graphical element representing the primary meeting object 121A to a graphical element 122A representing the start time of the secondary meeting object and the end time of the secondary meeting object having a given duration, e.g., 25 minutes.

FIG. 2C shows a state where the system receives input data for selecting the primary meeting object 121A and associating that object with a start time of the secondary meeting object 122A and an end time of the secondary meeting object 122A that define a duration of the secondary meeting object 122A, wherein the duration of the secondary meeting object 122A is less than a duration of the primary meeting object 121A that corresponds to secondary meeting object 122A. The user interface is arranged to receive information in a number of different formats. The duration can be selected by the user by typing in an entry, such as 25 minutes, for the secondary calendar object. If they wish to have their attendance of the TPM meeting be only 25 minutes starting at 8:15, they can enter the start time and the duration. The duration and the start time can also be used to determine an end time. In this example, the end time for the 25 minute attendance of the TPM meeting would be 8:40 given the user-provided duration and the start time. In other embodiments, the UI can be arranged to receive a text entry or selection of an end time, and the duration can be based on the start time and the end time.

In response to the input shown in FIG. 2C, the system generates data that associates the primary meeting object to the secondary meeting object. For example, as shown in FIG. 2D, in response to the input causing the selection of the start time of the secondary meeting object 122A and the end time of the secondary meeting object 122A, the system stores the start time of the secondary meeting object 122A and the end time of the secondary meeting object 122A in a secondary calendar 111. The secondary meeting object 122A may also include an meeting identifier to associate the secondary meeting object 122A with the selected primary meeting object. For example, the primary meeting object 121A and the secondary meeting object 122A may both share a common title and a unique identifier. In this example, a meeting identifier of the TPM meeting in the primary calendar is copied to the secondary calendar and the secondary calendar Also stores the start time and end time defining User A's shortened attendance period.

FIGS. 2E and 2F show that the Sales meeting of the primary calendar is selected by an input and associated with a second 25-minute time slot. Resulting in a 25 minute allocated attendance confirmation for the Sales meeting, which is also stored in the secondary calendar. FIG. 2F also shows that the secondary calendar also includes other meeting objects that are provided by the conflict panel such as breaks and other reserved time.

FIG. 2G shows a feature that allows a user to edit different aspects of the secondary calendar objects. For instance, they use interface allows the user to adjust the duration of a secondary calendar object. This can be achieved by allowing a user to enter a text entry of a duration or edit a start time or end of a particular secondary object. In this particular example, the user provides input to change the duration of the secondary calendar object for the Sales meeting from 25 minutes to 10 minutes.

FIG. 2H shows other inputs that associate other meetings with the remaining time slots. This results with the secondary calendar defining shortened attendance periods for the user, User A 10A, having an abbreviated or partial attendance for each of the selected primary meetings.

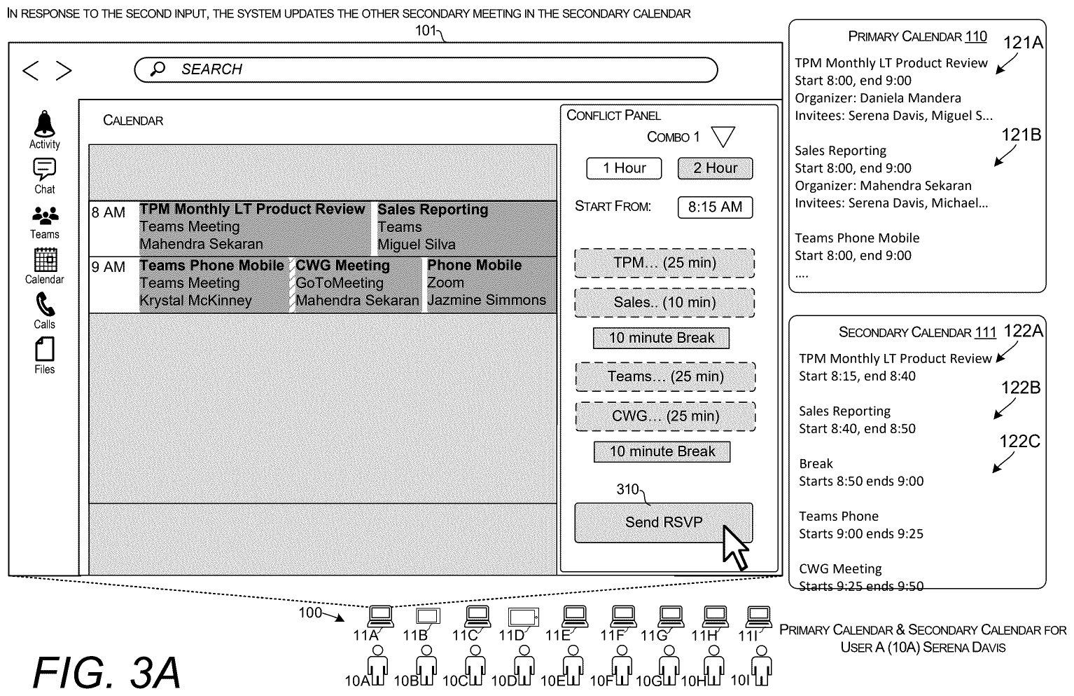

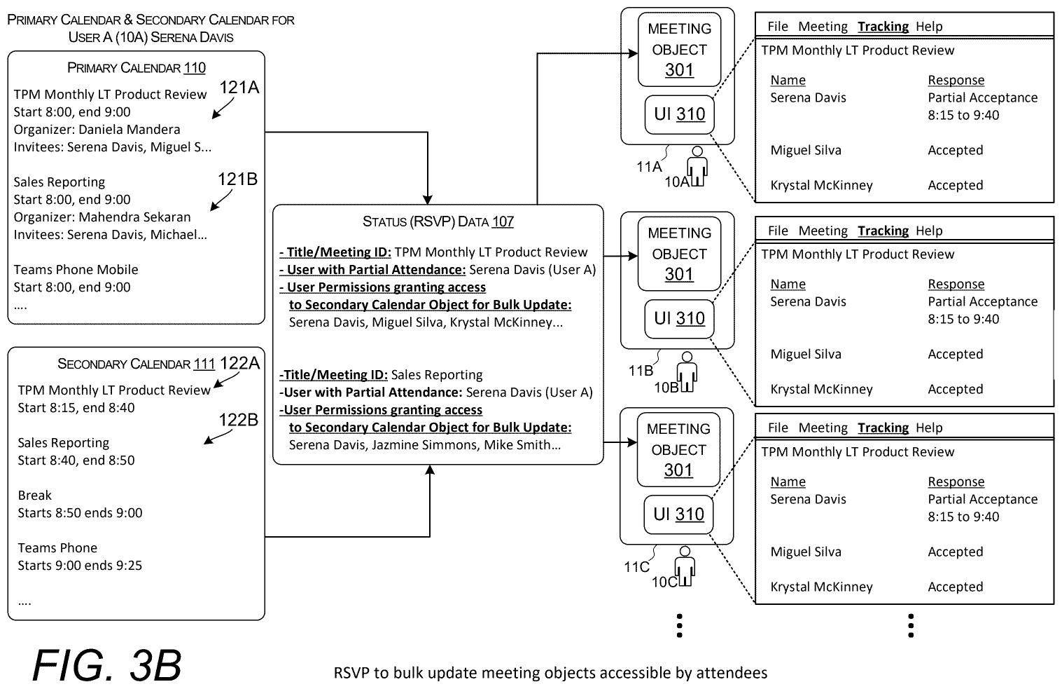

FIGS. 3A and 3B show a process where bulk RSVP data is generated for other users to be able to see the partial attendance for each meeting that is selected by a particular user, such as User A. This can be initiated, as shown in FIG. 3A, by a selection of a control element 310 of the conflict menu. Although this example involves a user interface control element, the bulk RSVP data can be generated by the use of a voice command or other input gesture.

As shown in FIG. 3B, in response to the input, the system can generate RSVP data to update meeting objects that are accessible by meeting attendees. In this process, the attendee list is obtained from primary calendar, and the attendee status of the user with the abbreviated attendance schedule, such as User A, is obtained by from the secondary calendar. This process can include generating status RSVP data 107 by accessing the primary meeting object 121A to obtain identities of attendees 10A-10F of the primary meeting object 121A, and accessing the secondary meeting object 122A of the secondary calendar 111 to obtain the start time of the secondary meeting object 122A and the end time of the secondary meeting object 122A.

Also shown in FIG. 3B, the system can update meeting objects accessible by attendees to provide notice of a user's shortened attendance of a meeting. This can include updating meeting objects 301 accessible by the attendees 10A-10E of the primary meeting object 121A with the status RSVP data 107, wherein the status RSVP data 107 indicates that a user 10A has accepted an invitation for the primary meeting object 121A, the status data 107 further indicating that an attendance duration of the user 10A is less than the duration of the primary meeting object 121A.

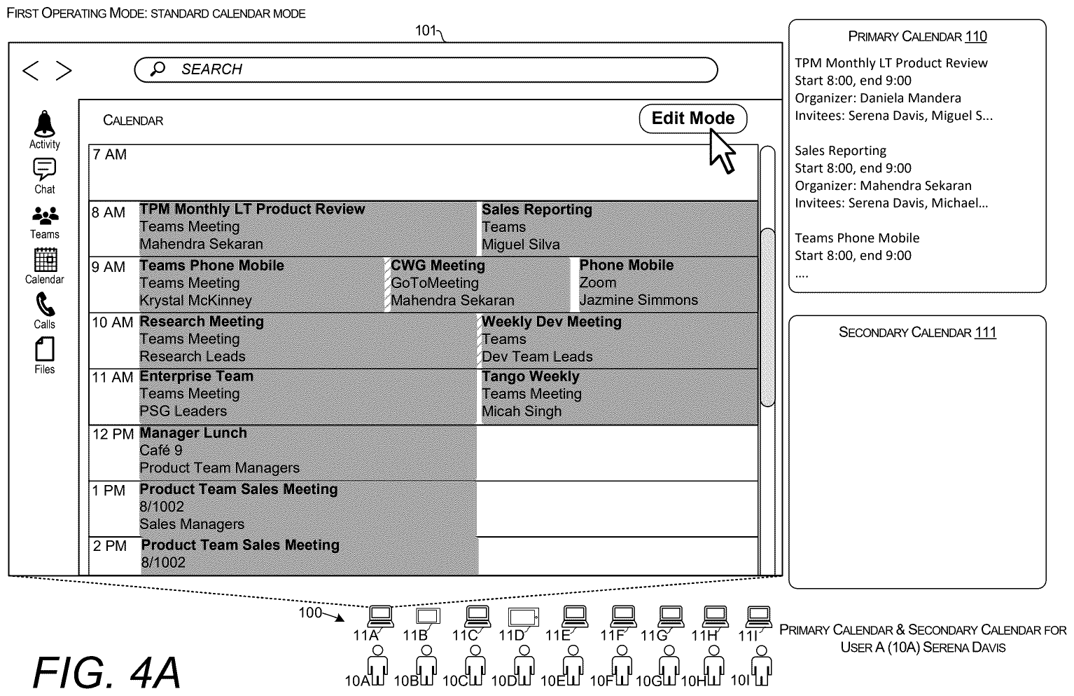

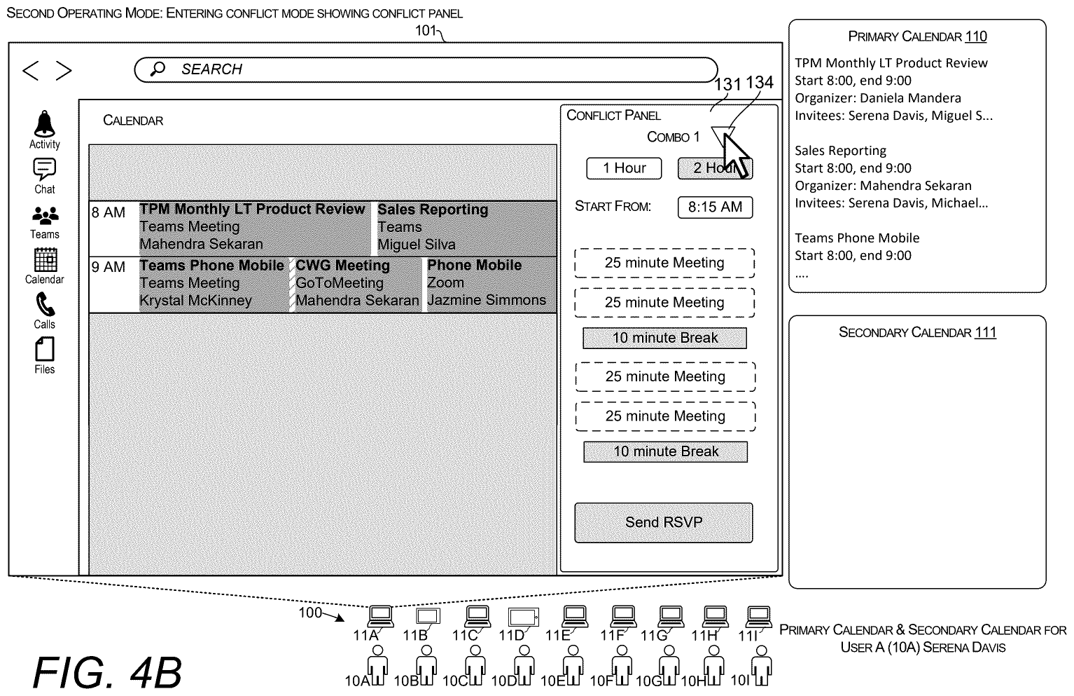

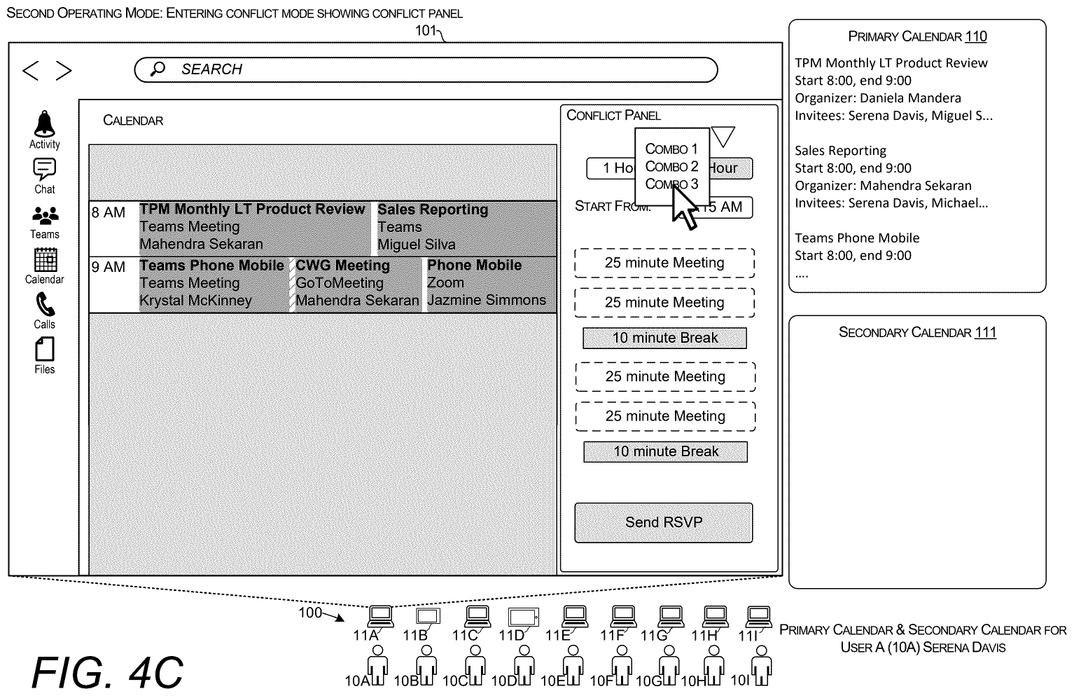

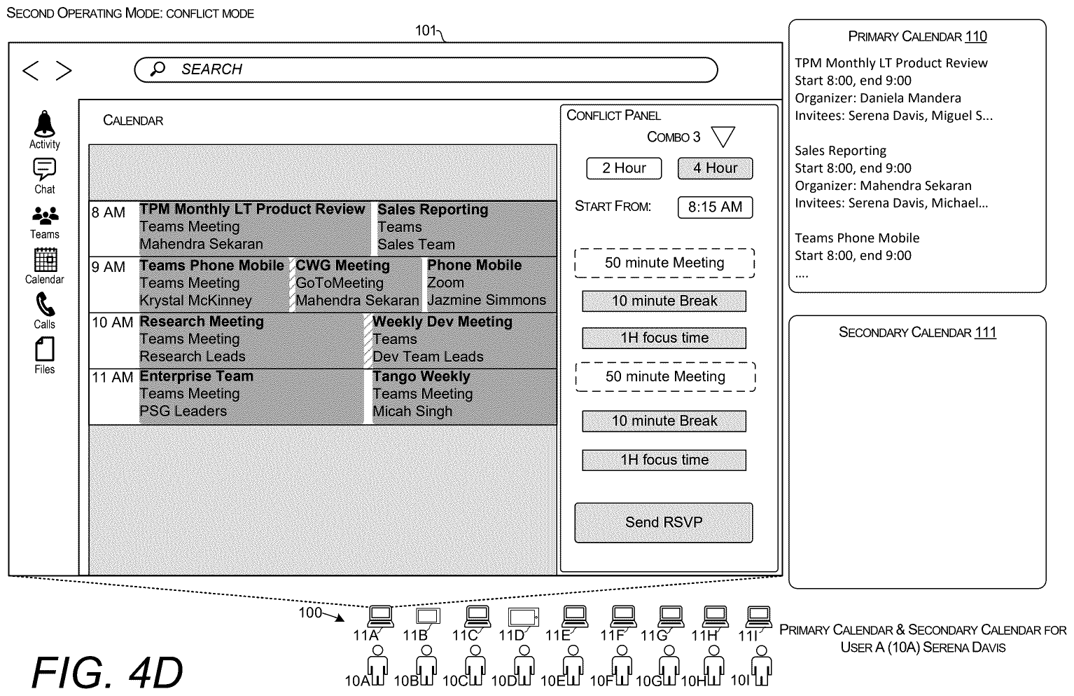

FIGS. 4A-4D show examples of a UI having a menu for selecting templates having different time slots for the secondary meetings. FIG. 4A shows a phase of a process for configurating secondary calendars where the system displays a first template defining time slots of a secondary calendar. The state of the system of FIG. 4A is in regular calendar mode. Where the system can edit individual meetings of the primary calendar. When the user selects the edit mode button, the system displays the UI of FIG. 4B, which shows the system in conflict mode showing the conflict menu. The conflict menu shows a first template (Combo 1) first set of time slots of the secondary calendar. This includes four 25-minute meetings that start at 8:15 and two break slots. This template also includes a filter to show a 2-hour window for the primary calendar. Also shown, the UI has a control element 134 for causing a display of a menu for other templates. In response to the selection of the control element 134, as shown in FIG. 4C, the menu of templates is displayed. FIG. 4C also shows a user selection of another template (Combo 3) from the menu of templates.

FIG. 4D shows a rendering of the other template (Combo 3) that includes a second set of time slots that is used for populating the data fields of the secondary calendar. This includes 2 50-minute meetings that start at 8:15 and two break slots and two focus time slots. Each break slot and focus time slot reserves time for the user and restricts the user from accepting a portion of a meeting that overlaps this reserved time. This second template also includes a filter to show a 4-hour window for the primary calendar. These templates can be pre-determined by the communication application, or the templates can be configured by the communication application using historical activity data of the user.

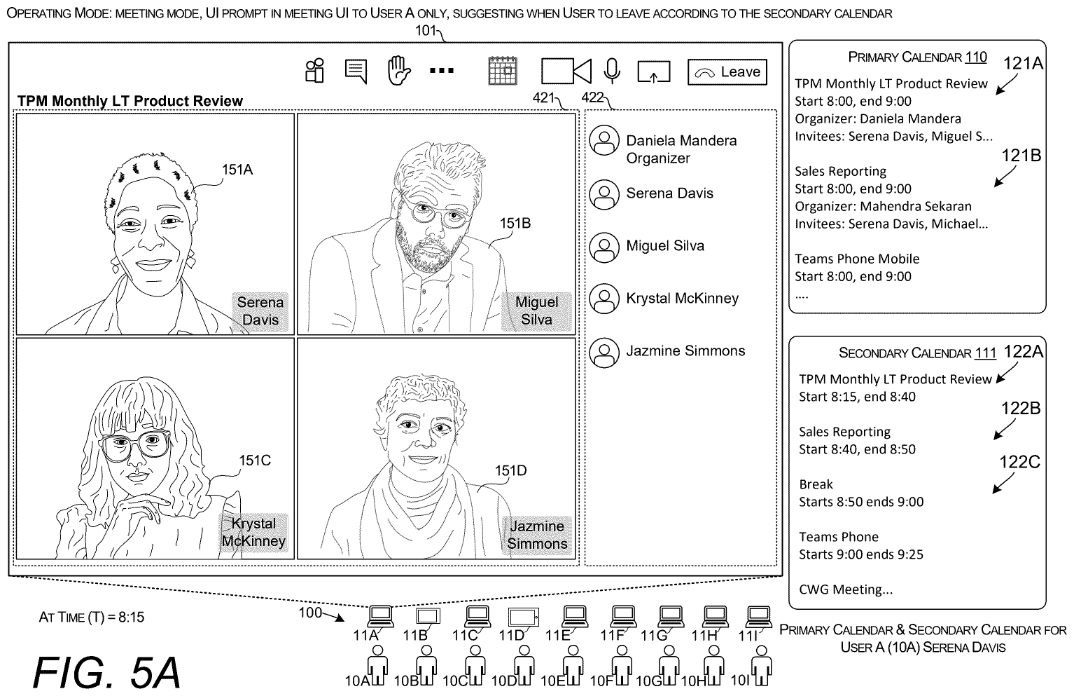

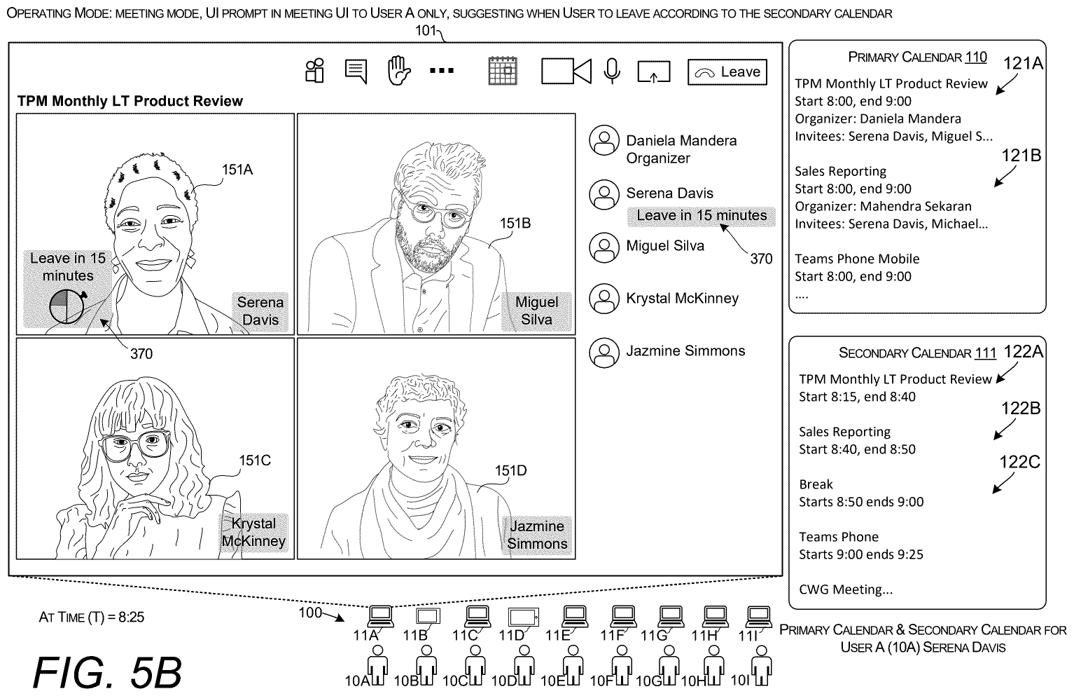

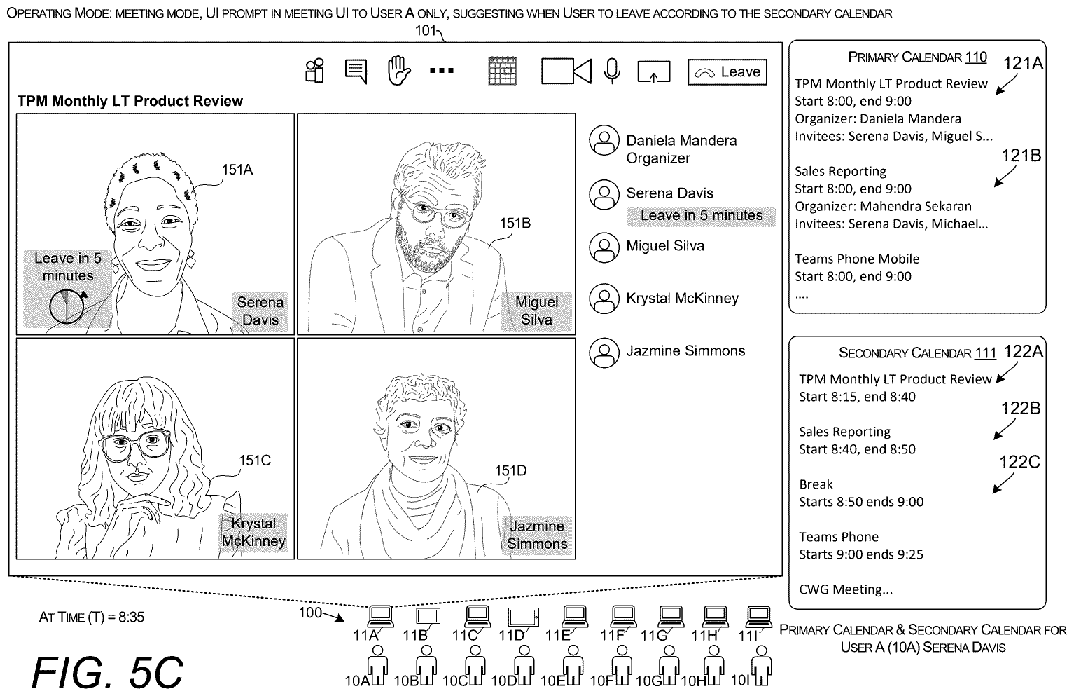

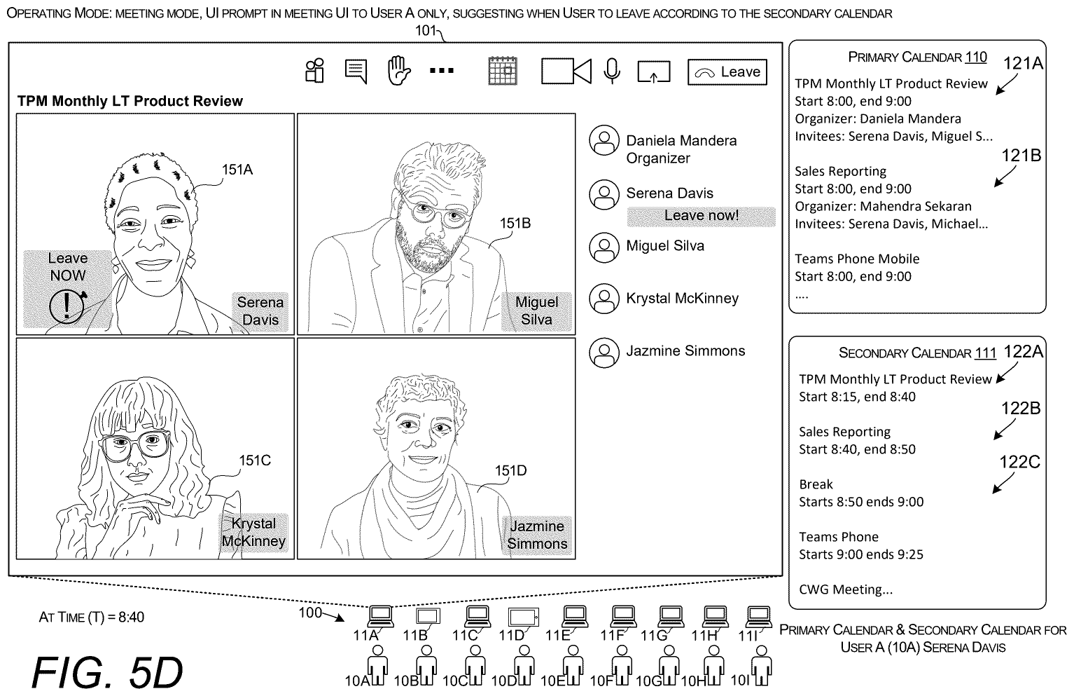

FIGS. 5A-5D shows a process for guiding a user through a schedule while attending meetings with a shortened schedule. In this example, notifications are displayed to a user, such as User A, who is the owner of the secondary calendar defining a shortened attendance period of a primary meeting of a primary calendar. In each of the UI's shown herein, each user 10 corresponds to a user rendering 151. For example, User A 10A is displayed in a rendering 151A. Also, in the examples described herein, the UI also includes two regions: first region 421 reserved for live video streams of the participants and a second region 422 reserved for user status information.

FIG. 5A shows a state of a meeting where the system generates notifications showing User A 10A when to leave a first meeting to join the second meeting. In general, a notification is shown when a running time of the meeting meets a threshold with respect to an end time of User A's secondary meeting object. For example, if a threshold is 15 minutes and there is more than 15 minutes between the running time of the meeting and the end time of User A's secondary meeting object, the system does not display a notification. In the state shown in FIG. 5A, the system is monitoring the running time of the meeting, currently at Time (T)=8:15, which does not meet a threshold, and a notification is not displayed.

FIG. 5B shows a state of the meeting where the running time of the meeting is at Time (T)=8:25, which is within the threshold of time to the end time of User A's secondary meeting object. In response, the system displays a notification 370 to instruct the user that they are to leave the meeting. FIG. 5C shows that the notification can be in the form of a countdown timer to a time to leave a meeting. The countdown can start at a time that is from a threshold time of the end time of the secondary meeting of the secondary calendar. FIG. 5D shows the meeting at a time that meets or exceeds a threshold and a notification is displayed showing that the system is going to cause that person to leave the meeting or providing a notification to tell the user to leave the meeting. At that time, the system may automatically transfer that user to another meeting, e.g, the Sales meeting in the secondary calendar, or in some embodiments, the system provides the updated notification telling the user to leave and the allows the user to stay for a predetermined period of time before displaying another notification.

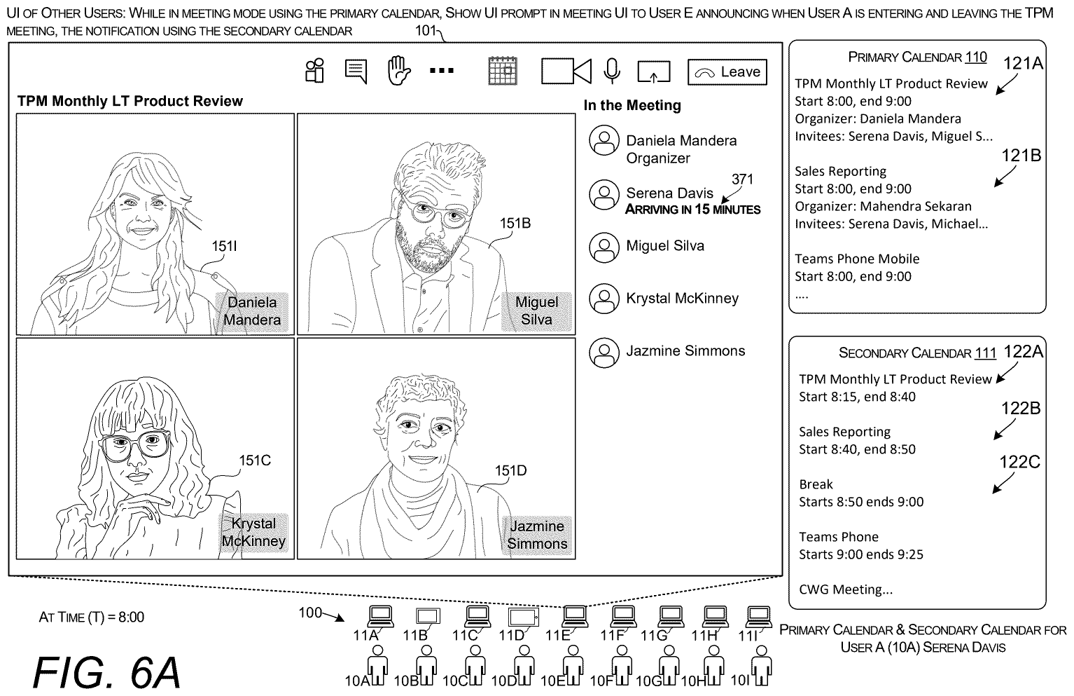

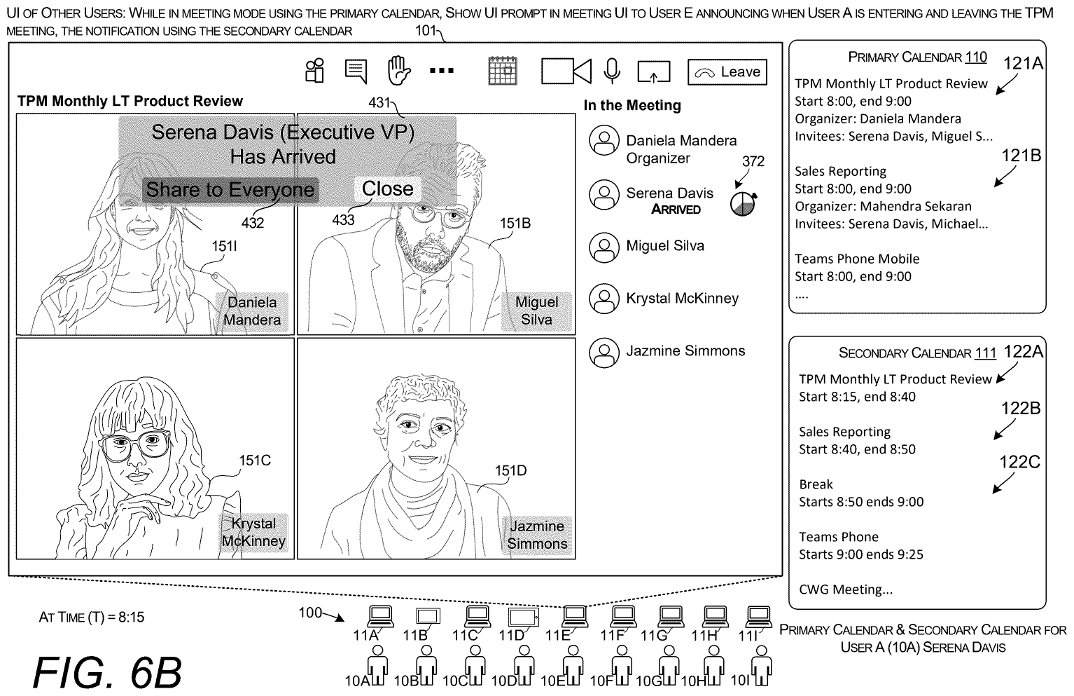

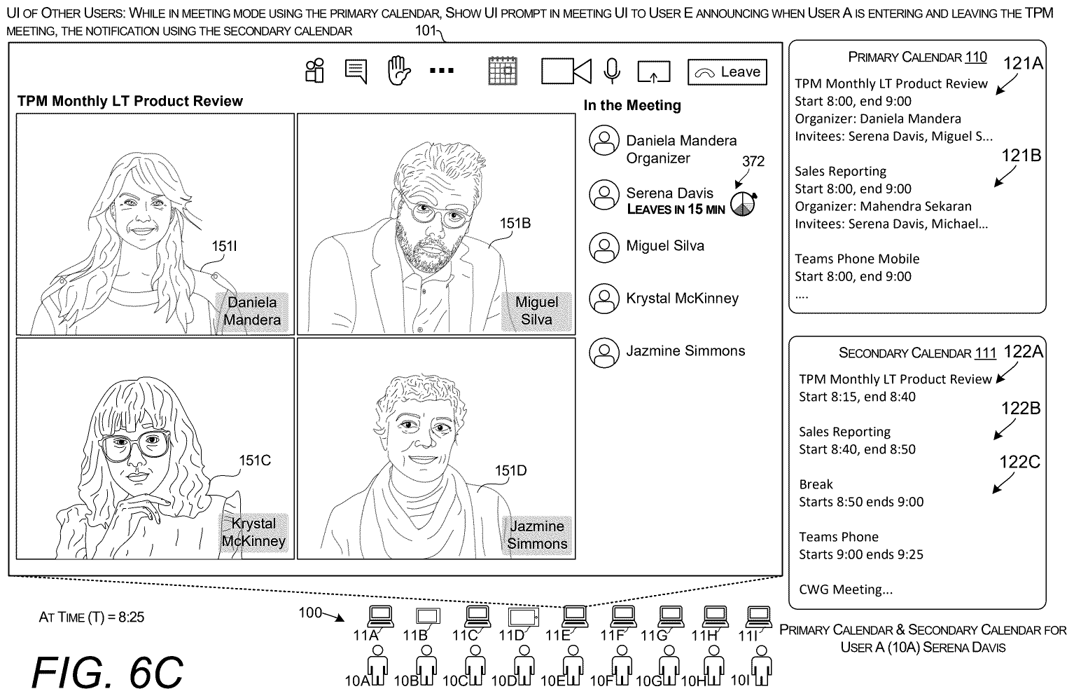

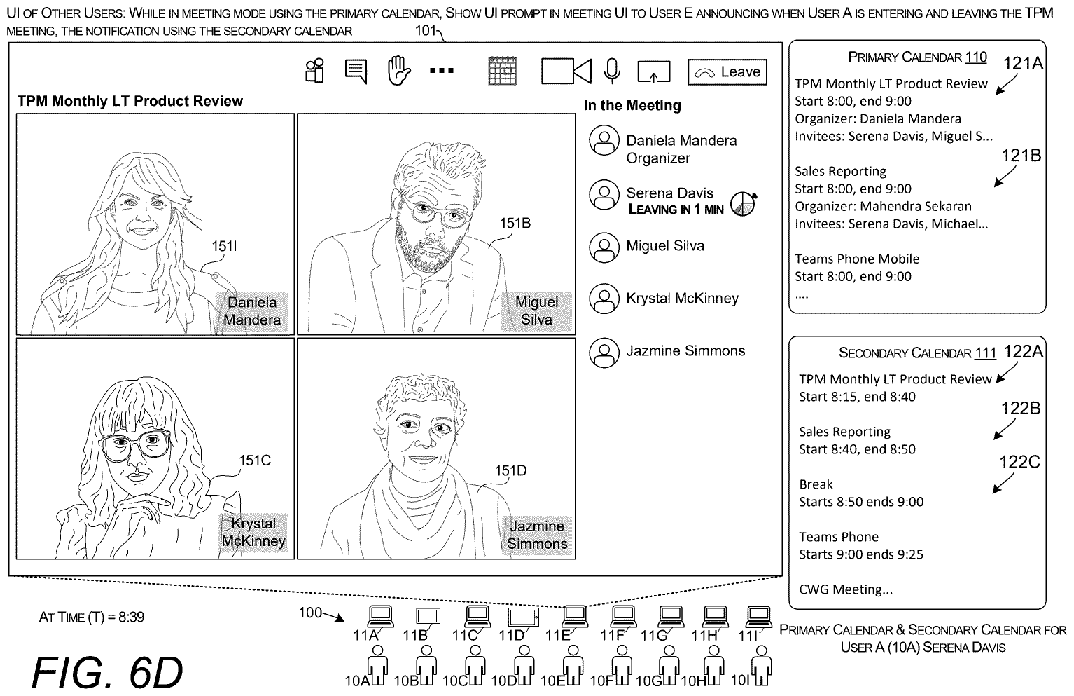

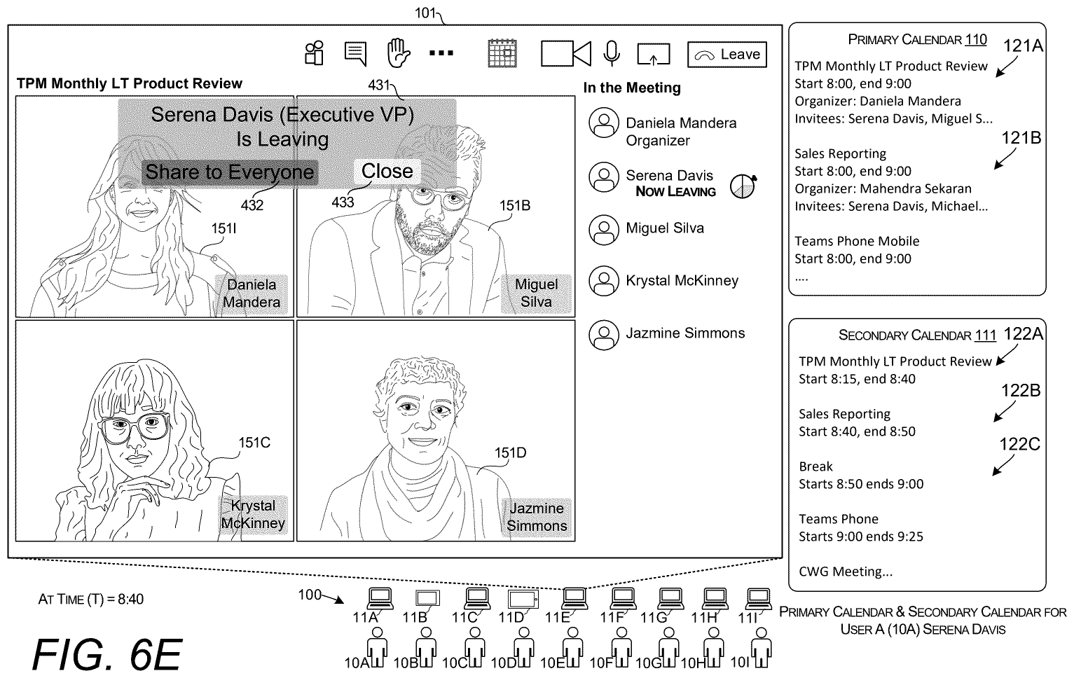

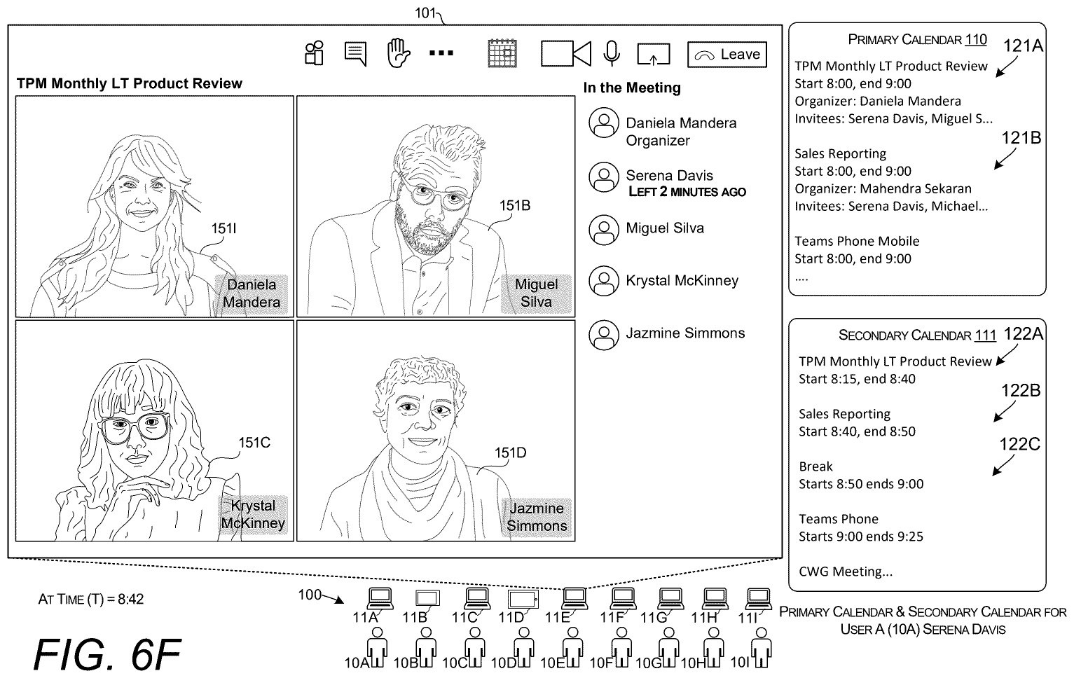

FIGS. 6A-6F shows an example of a UI that displays a notification to other users of a meeting, e.g., displayed on User E 10E, who are attendees of the TPM meeting. The notification indicates, such as, how soon a particular user, such as User A, will be arriving or leaving a particular meeting, e.g., the TPM meeting defined in User A's primary calendar. In this example, notifications are displayed to other users 10B-10D other than User A, who is the owner of the secondary calendar defining a shortened attendance period.

FIG. 6A shows a meeting at a time that meets a threshold and a notification 371 is displayed showing a specific time of when a user is to arrive at a meeting. In this analysis, the system accesses a primary calendar 110 comprising a primary meeting object 121A and a secondary calendar 111 comprising a secondary meeting object 122A, where the primary meeting object 121A defines a duration of a primary meeting and the secondary meeting object 122A indicates an attendance duration of the user 10A that is less than the duration the primary meeting object 121A.

This backend data structure and operations are utilized to determine when a notification is to be displayed. The system monitors a running time during the primary meeting to determine that the running time of the primary meeting is within a threshold of a triggering time defined in the secondary meeting object 122A. The triggering time can be a start or end time of the user's shortened schedule. In this example, the triggering time is at the start of the user's shortened schedule which is 8:15 and an example threshold is 15 minutes. Given this scenario, at running time=8:00, the notification 371 is displayed to the attendees other than User A, who has the shortened attendance schedule. In some embodiments, the notification 371 is positioned next to the user's name or icon, indicating, such as, how soon the user will be arriving or leaving the meeting.

FIG. 6B shows the UI when the meeting running time is at 8:15, which is the same time as the start time defined in the user's secondary calendar. In response to detecting these conditions, the system displays another notification 431 showing that User A has joined the meeting. This notification 431 also includes a first control button 432 that enables a particular user to share this announcement with other meeting participants, and a second control button 433 to close the notification 431. In this embodiment, the notification also includes a graphical indicator 372 indicating a duration that User A is to attend the meeting.

As the meeting progresses with User A as a participant, other indicators are displayed showing when User A is going to leave the meeting. For instance, as shown in FIG. 6C, during the TPM meeting, the system displays a notification 372 to the participants, e.g., Users B through User E, that User A is scheduled to leave the meeting. This notification can be displayed in response to the running time of the meeting being within a threshold time from the end of the attendance period defined in the secondary meeting of the secondary calendar of User A, or from the start time of another secondary meeting (the Sales meeting) of the secondary calendar of User A. In this example, User A is scheduled to end their attendance of the TPM meeting at 8:40, which in this example is a threshold time from the current time, thus the notification announcing User A's departure is displayed. In this embodiment, the notification also includes a graphical indicator having a two-color dial: the first color, e.g., the darker shade, has a shape that indicates the duration that User A is to remain in the meeting, and a second color, e.g., the lighter shade, has a shape that indicates a countdown of how long User A has been in the meeting.

The embodiment shown in FIG. 6D includes a countdown timer, such as the example shown where at running time=8:39, the notification shows that User A will be leaving in 1 minute. FIG. 6E shows that, at time 8:40, that User A is leaving the meeting. This also shows a control button 432 to share the notification with other attendees or a control 433 to close the notification 431. At time 8:42, as shown in FIG. 6F, the UI shows a notification that the user left 2 minutes ago.

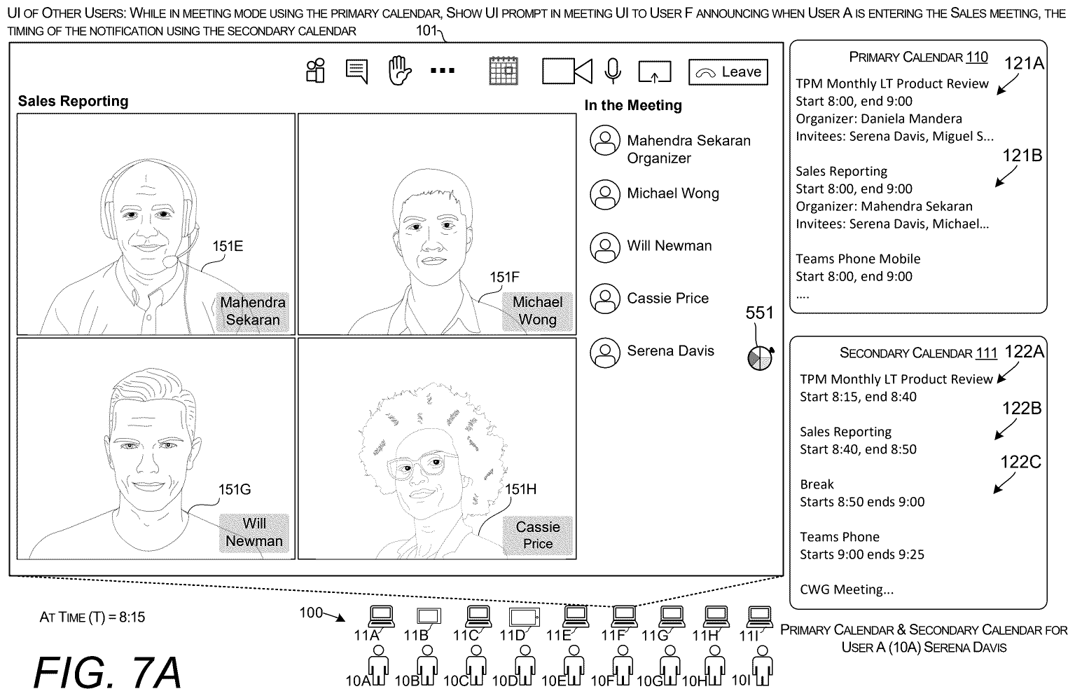

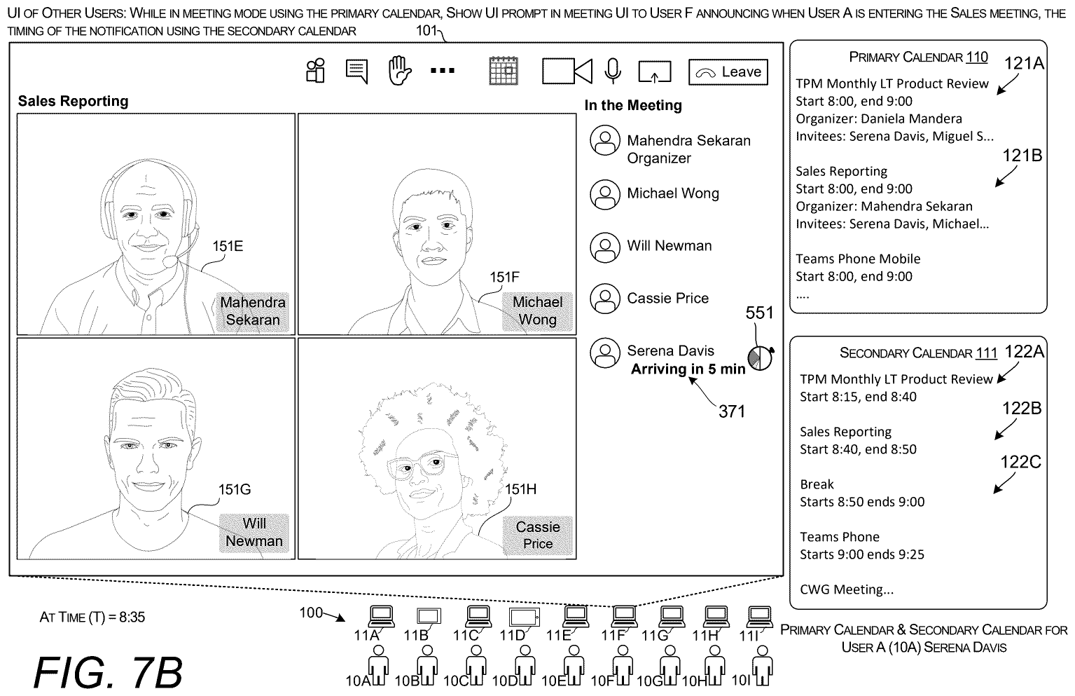

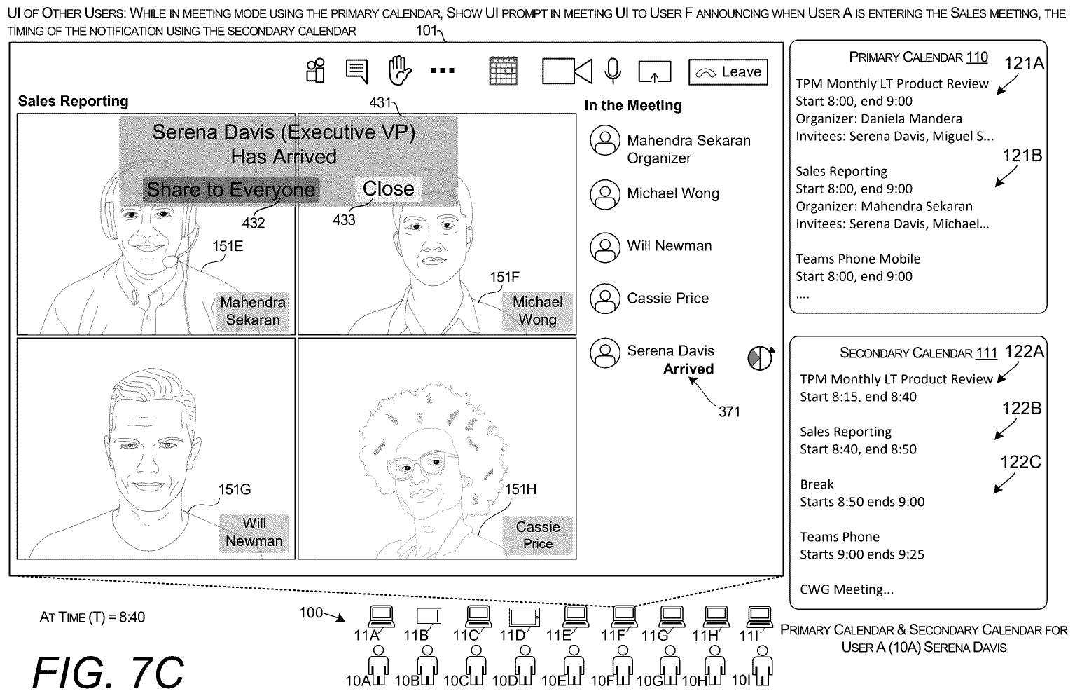

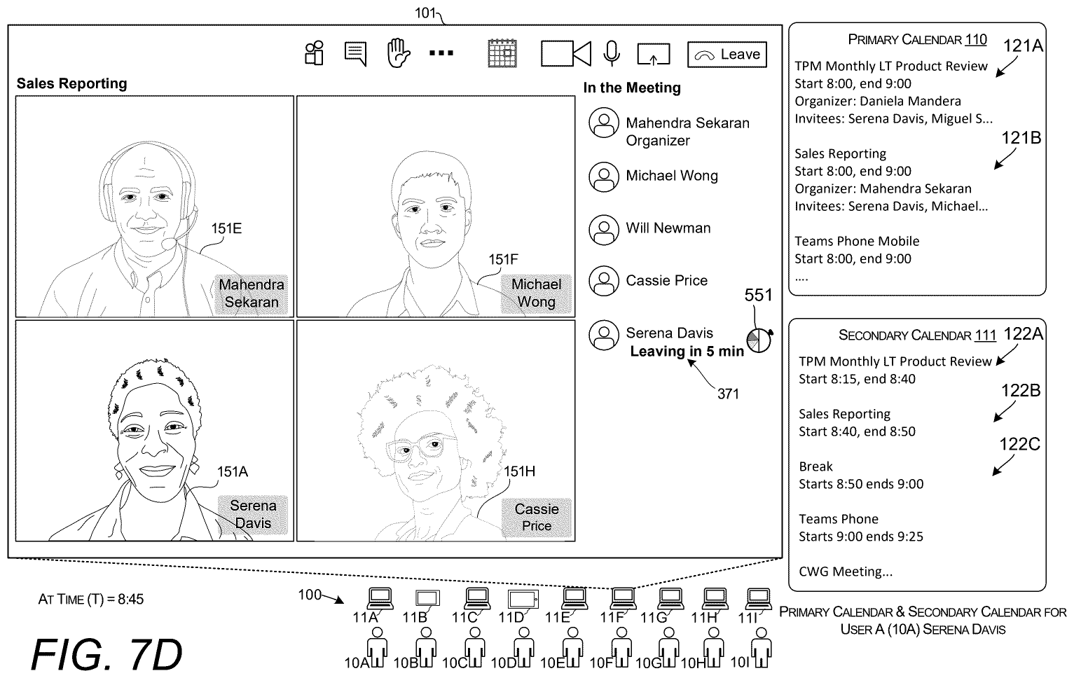

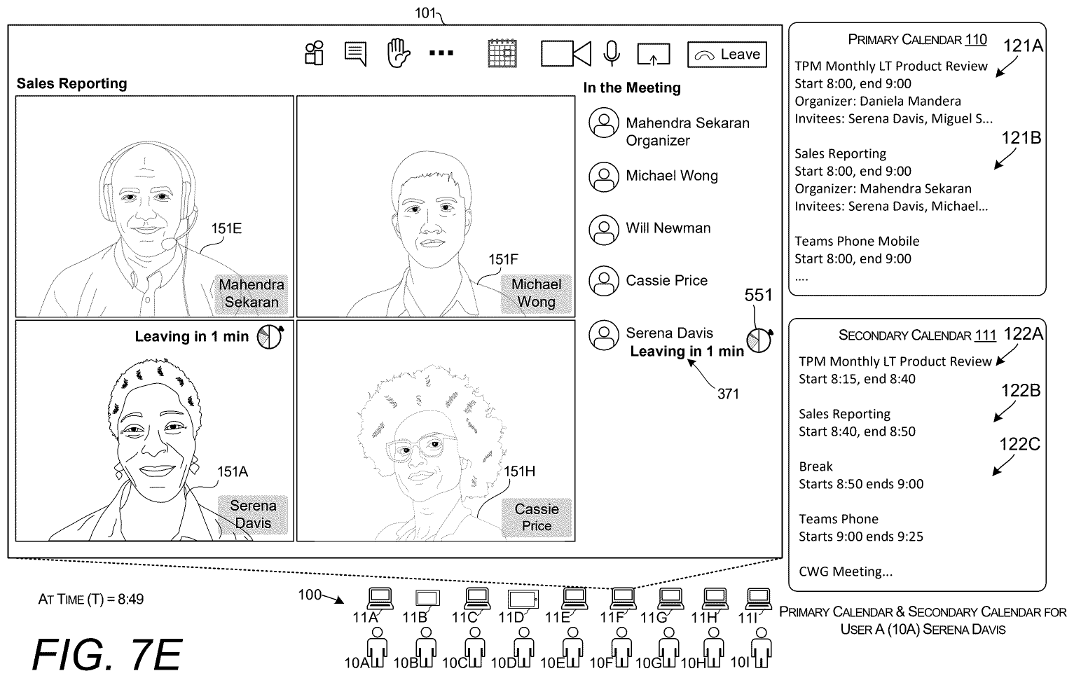

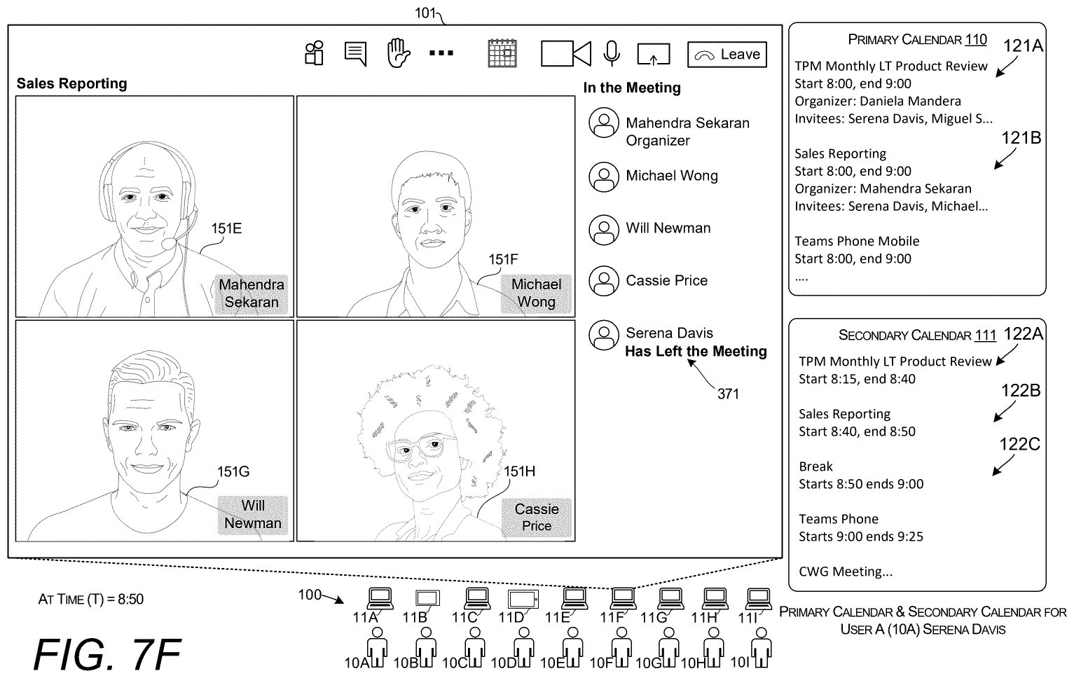

FIGS. 7A-7F shows an example of a UI that displays a notification to users of a meeting, e.g., displayed on User E 10E, who are attendees of the TPM meeting. The notification indicates how soon the user with a shortened schedule, e.g., User A, will be arriving and leaving a particular meeting. This example is from the perspective of participants of the second meeting, the Sales Reporting meeting, of the user's primary calendar. This meeting shows User A being transferred from another meeting, e.g., the TPM meeting.

FIG. 7A shows a time of a meeting that meets a threshold and a notification is displayed showing a specific time of when a user is to arrive at a meeting. At this stage, the system accesses a primary calendar 110 comprising a primary meeting object 121A and a secondary calendar 111 comprising a secondary meeting object 122A, where the primary meeting object 121A defines a duration of a primary meeting and the secondary meeting object 122A indicates an attendance duration of the user 10A that is less than the duration the primary meeting object 121A. This backend data structure and operations are utilized to determine when a notification is to be displayed.

The system monitors a running time during the primary meeting to determine that the running time of the primary meeting is within a threshold of a triggering time defined in the secondary meeting object 122A. The triggering time can be a start or end time of the user's shortened schedule. In this example the triggering time is at the start of the user's shortened schedule. For this example, the example threshold is 15 minutes, the current time of the meeting, e.g., the running time is 8:15. Given these conditions, a text notification showing User A's arrival is not displayed to the attendees 10E-10H, including User F, as shown in FIG. 7A.

In some embodiments, the UI can include a graphical indicator 551 showing an attendance duration for User A. This indicator can concurrently show when User A is going to attend and show a running countdown to the User A's arrival. In this embodiment, the graphical indicator has a two-color dial: the first color, e.g., the darker color, has a shape that indicates the duration of when User A is going to attend, and a second color, e.g., the lighter color, has a shape that indicates a countdown of when the user is going to arrive. For instance, as shown in FIG. 7B, the shape of the second color has changed to indicate that User A is arriving in 5 minutes. This graphical indicator can be displayed continuously or this graphical indicator can be displayed in response to the time of the meeting reaching a threshold time with respect to a time of the secondary calendar.

FIG. 7B also shows the UI when the meeting running time is at 8:35, which is five minutes prior to the start time defined in the user's start time in their secondary calendar. In response to detecting these conditions, the system displays a notification 371 showing a remaining time until User A's arrival. This is displayed concurrently with the graphical indicator 551. Then, as shown in FIG. 7C, at 8:40, the system displays a notification 371 showing that User A has joined the meeting. This notification 371, which is positioned in the status region, is displayed concurrently with a second notification 431 that includes a first control button 432 that enables a particular user to share this announcement with other meeting participants, and a second control button 433 to close the notification 431.

As the meeting progresses with User A as a participant, other indicators are displayed showing when User A is going to leave the meeting. For instance, as shown in FIG. 7D, during the Sales meeting, the system displays a notification to the participants, e.g., User E-User H, that User A is scheduled to leave the meeting. This notification can be displayed in response to the running time of the meeting being within a threshold time from the end of the attendance period defined in the secondary meeting of the secondary calendar of User A. In this example, User A is scheduled to end their attendance of the Sales meeting at 8:50. With the current time at 8:45, which is a threshold time within the end time of User A's secondary calendar, the system displays the notification announcing User A's departure in 5 minutes. Also shown in FIGS. 7D and 7E, the notification and the graphical indicator 551 show how much time is left in the User A's attendance period. FIG. 7F shows, at time 8:50 that User A has left the meeting.

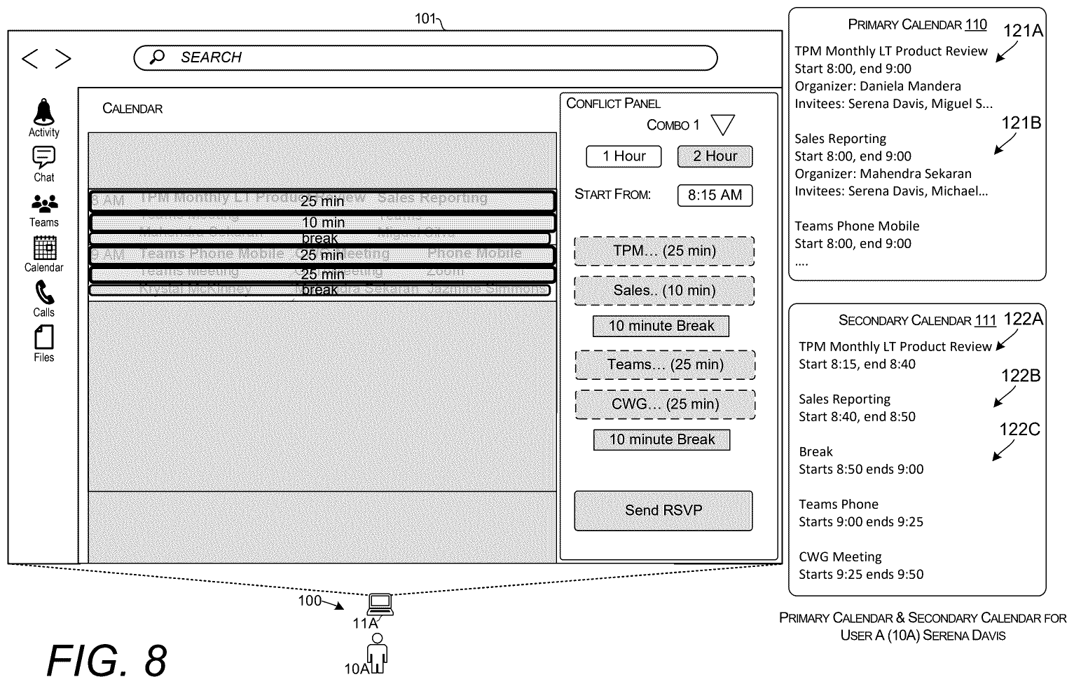

FIG. 8 shows an example of a UI that includes a graphical overlay of the secondary calendar over the primary calendar. This shows a graphical representation of how the secondary meeting objects relate to a user's primary calendar objects. The graphical representation of the secondary meeting objects are displayed as overlays on the graphical representation of the primary meeting objects. The graphical representation of the secondary meeting objects are semi-transparent to allow the user to view which portion of a primary meeting they are attending.

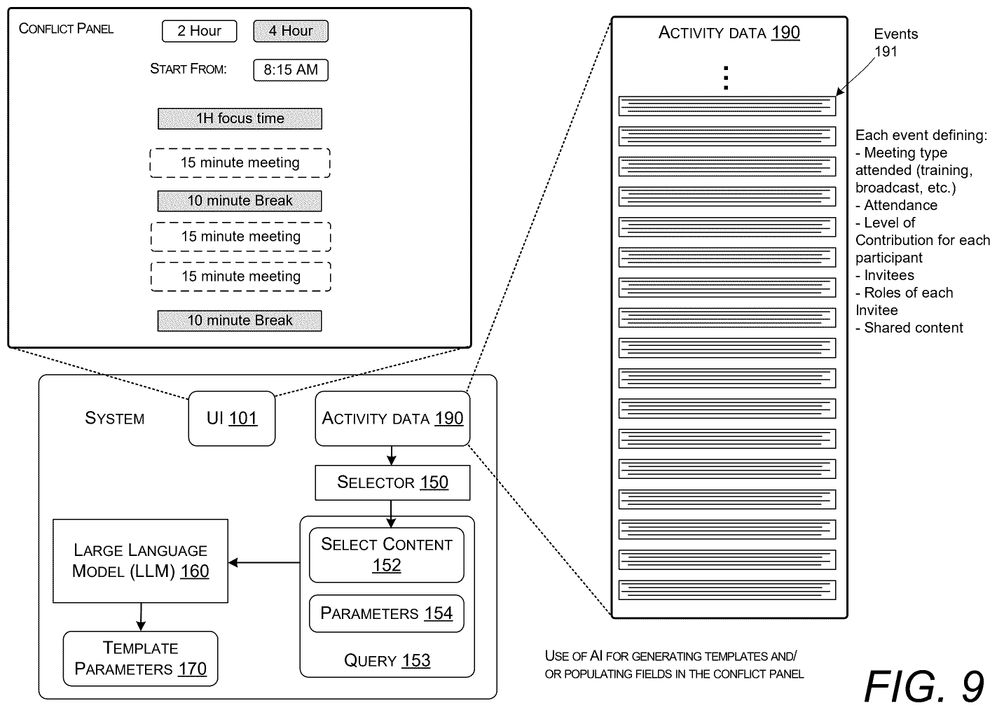

In some embodiments, the system can also use an AI model to generate customized conflict panel templates and to populate fields of a secondary calendar for a particular user. An example of such embodiments is shown in FIG. 9. The system can utilize an AI model, such as a large language model (“LLM 160”), to determine parameters for the conflict panel. For example, the AI model can utilize historical activity data pertaining to a person such as a number of meetings per day, attendance durations for each meeting, a number of breaks, durations for each break, a number of focus time reservations, durations for focus time reservations, etc. This historical data can be used to determine parameters for the conflict panel. The parameters for the conflict panel can include a number of meetings they are to attend, the time slots having a shortened schedule for each meeting, a number of breaks that should be on their schedule, etc. The LLM can also be used to assign primary meetings with the determined time slots. For example, if a user has a historical pattern that shows a regular attendance for the first 10 minutes of a recurring 1-hour meeting, the system can generate a conflict panel template that defines a time slot for a particular part of that recurring meeting, and automatically associate that recurring meeting of a primary calendar with the 10 minute time slot. In one illustrative example, if a user has a recurring meeting every Monday from 9:00 AM to 10:00 PM defined on their primary calendar, and that user has a history of only attending that meeting from 9:00 to 9:10, the system can generate a secondary calendar object for a secondary calendar defining a time slot between 9:00 and 9:10. The secondary calendar will also include a meeting ID to associate that secondary calendar object to the primary calendar object for the recurring meeting. The system can then generate an automated acceptance of that series and also indicate to the other users their acceptance of that series is limited to a shortened schedule.

The parameters for the conflict panel are determined using one or more factors based on the activity data 190 of a particular user. The activity data can define activity such as a series of events 191, e.g., prior meetings, and each event can define a meeting type of attended meetings, e.g., training, broadcast, etc., attendance records, a level of contribution for a person, such as a number of times a person talked in a meeting, a number of reactions, gestures, etc., a number of invitees for each meeting that was attended, the roles of each invitee, a quantity of shared content such as shared documents and chat threads, and a level of activity of others around the user's shared content, such as conversational input or document comments. All of these factors and other activity data pertaining to a user, such as User A and other users who met with User A, can be used to build a query for a large language model 160 (“LLM 160”). Thus, if a person is more engaged, e.g., their level of conversation is above a threshold, in the first 15 minutes of a 1-hour meeting, the system can generate a secondary calendar event indicating a partial acceptance for the first 15 minutes of that 1-hour meeting.

Any combination of factors derived from the activity data can be used to generate a query for the LLM. The query can include select background content (“select content 152”) and query parameters 154. In some embodiments, a selector module 150 (“selector 150”) can be used to identify portions of the activity data 190 to use as background content, which is referred to herein as grounding data. The selector module identifies portions of the activity data 190 based on the activity of the user, e.g., User A, and other meeting participants. For example, the selector may identify events 191, e.g., each meeting, that includes the first user, e.g., User A, who is generating a secondary calendar defining partial attendance for meetings. The select content can also include events 191 having characteristics pertaining to the user's profile or historical behavior, include a Meeting type (training, broadcast, one-on-one, department group session, etc.), a Platform type, (Teams, GotoMeeting, Zoom), a Meeting Status (Canceled, Active), Invitees of each event, Roles of each person, and Shared content. Once the select content 152, e.g., selected events involving predetermined activity, content, and/or people, is determined, the system can generate one or queries 153 and query parameters 154 to send to the LLM 160 with the select content 152. The select content can also include the upcoming meetings and all of the data defining the characteristics of those meetings, e.g., the invitees, the shared content, a time, date, the platform, a meeting status, etc.

The parameters of the queries can include user preferences and specific questions regarding one or more of the factors described herein. For example, a query parameter can include a phrase, such as “generate a meeting template based on my past activity for the last 2 months in which I shared content.” This causes the selector to only include events for that user for the last two months, and that data would be included in the query as select content 152. This type of query would influence the system to bring highlight or emphasis to meetings that pertain to our current project or projects having a high priority. In another example, a query parameter can include a phrase, such as “generate a meeting template based on my past activity for the last month that also included managers and executives that sent me a message during the meeting during my presentations.” This causes the system to select more specific data for the query based on more specific activity. Examples such as these cause the system to build specific templates that align secondary time slots with future meetings in which a person is a presenter. These examples are for illustrative purposes and are not to be construed as limiting, as the queries generated by the system use activity data defining past meetings and future meetings are configured to cause the LLM 160 to use any combination of factors to generate template parameters 170. The template parameters 170 can be used to generate a conflict panel or directly be used to generate a secondary calendar.

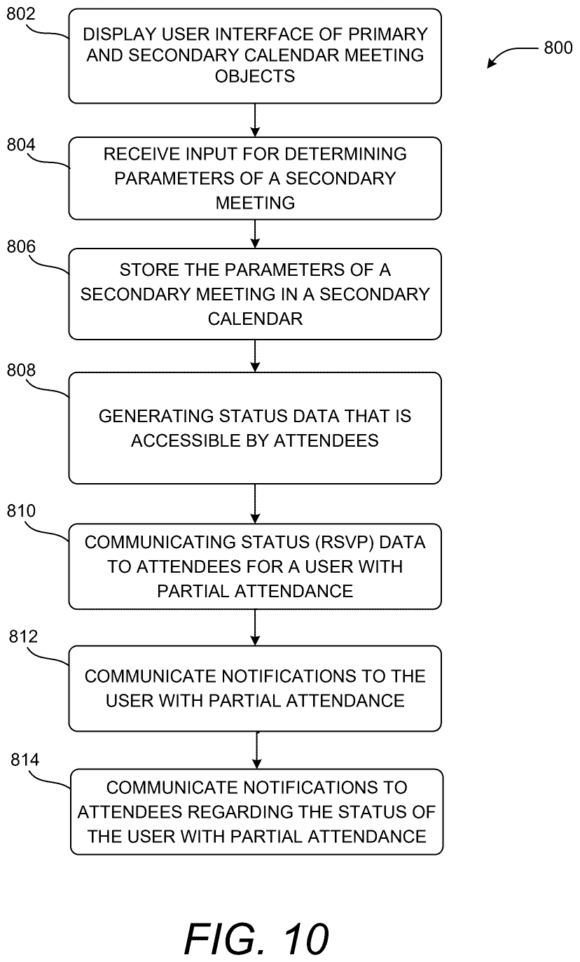

Turning now to FIG. 10, aspects of a routine 800 that causes the generation of a secondary calendar and notification for providing notifications for the secondary calendar events are shown and described below. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in its entirety. Some or all operations of the methods, and/or substantially equivalent operations, can be performed by execution of computer-readable instructions included on a computer-storage media and computer-readable media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine are described herein as being implemented, at least in part, by an application, component and/or circuit, such as a device module that can be included in any one of the memory components disclosed herein, including but not limited to RAM. In some configurations, the device module can be a dynamically linked library (DLL), a statically linked library, functionality enabled by an application programing interface (API), a compiled program, an interpreted program, a script or any other executable set of instructions. Data, such as input data or a signal from a sensor, received by the device module can be stored in a data structure in one or more memory components. The data can be retrieved from the data structure by addressing links or references to the data structure.

Although the following illustration refers to the components depicted in the present application, it can be appreciated that the operations of the routine may be also implemented in many other ways. For example, the routine may be implemented, at least in part, by a processor or circuit of another remote computer (which can be a server) or a local processor or circuit of a local computer (which can be a client device receiving a message or a client device sending the message). Any aspect of the routine, which can include the generation of a prompt, communication of any of the messages with the prompt to an NLP algorithm, use of an NLP algorithm, or a display of a result generated by an NLP algorithm, can be performed on either a device sending a message, a device receiving a message, or on a server managing communication of the messages for a thread. In addition, one or more of the operations of the routine may alternatively or additionally be implemented, at least in part, by a chipset working alone or in conjunction with other software modules. Any service, circuit or application suitable for providing input data indicating the state of any device may be used in operations described herein.

The routine starts at operation 802 where the system displays a user interface of primary and secondary calendar meeting objects. In one example, FIG. 2B shows a UI and way to create a customized secondary calendar according to meeting objects from a primary calendar. The user interface 101 includes a number of primary meeting objects 121 retrieved from a primary calendar 110, the user interface 101 further comprising control elements for selecting a primary meeting object 121A from the primary meeting objects 121 for causing the system to generate a secondary meeting object 122A. This UI allows users to select a primary meeting to generate a secondary meeting object.

The system also controls permissions such that the secondary calendar can be edited while the system is in conflict mode. The communication program is restricted from editing the secondary calendar while in calendar mode. While in conflict mode, the communication application is configured to update the secondary calendar and is restricted from updating the primary calendar. In regular calendar mode, the communication application is configured to update the secondary calendar and the primary calendar. The permissions are configured to restrict a calendaring program, such as Outlook or Google Calendar, from editing the secondary calendar.

At operation 804, the system receives an input for determining parameters of a secondary meeting. This input also associates a meeting ID of a primary meeting to a secondary meeting. As shown in FIG. 2C, the UI can include a drag-and-drop feature for receiving a gesture for associating the primary meeting with secondary meeting time slots. This can include a template having a graphical element representing the start time of the secondary meeting object and the end time of the secondary meeting object, wherein the input data is generated from a drag-and-drop input gesture of moving a graphical element representing the primary meeting object to a graphical element representing the start time of the secondary meeting object and the end time of the secondary meeting object. The input gesture causing generation of data that associates the primary meeting object to the secondary meeting object.

At operation 806, the system can store the parameters of a secondary meeting in a secondary calendar. As shown in FIG. 2D, the data of the secondary meeting object stored in a secondary calendar. This can include storing the start time of the secondary meeting object 122A and the end time of the secondary meeting object 122A in a secondary calendar 111.

At operation 808, the system can generate status data that is accessible by attendees. As shown in FIG. 3B, the system can generate RSVP data to update meeting objects accessible by attendees. Attendee list obtained from primary calendar, status of partial attendee obtained by from the secondary calendar. Attendees can include an invitee or a person attending a meeting. Operation 808 can include generating status RSVP data 107 by accessing the primary meeting object 121A to obtain identities of attendees 10A-10F of the primary meeting object 121A, and by accessing the secondary meeting object 122A of the secondary calendar 111 to obtain the start time of the secondary meeting object 122A and the end time of the secondary meeting object 122A. For illustrative purposes, meeting “attendees” includes both an invitee or a person attending a meeting.

At operation 810, the system can communicate the status (RSVP) data to attendees for a user with partial attendance. Also shown in FIG. 3B, the system can update meeting objects accessible by attendees to provide notice of a user's shortened attendance of a meeting. This can include updating meeting objects 301 accessible by the attendees 10A-10F of the primary meeting object 121A with the status RSVP data 107, wherein the status RSVP data 107 indicates that a user 10A has accepted an invitation for the primary meeting object 121A. The status data 107 further indicating that an attendance duration of the user 10A is less than the duration of the duration of the primary meeting object 121A. This can be used to generate UI updates such as the TRACKING page shown in FIG. 3B.

At operation 812, the system can communicate notifications to the user with partial attendance. As shown in FIGS. 5A-5C, a UI can include a prompt to User A only, suggesting when User A should leave according to the secondary calendar. This can include transitioning from a predetermined operating mode to a meeting mode, wherein the predetermined operating mode displays control elements for selecting a primary meeting object 121A from the primary meeting objects 121 for causing the system to generate a secondary meeting object 122A, wherein the meeting mode displays video streams of users participating in a communication session. During the meeting mode, the system can monitor a running time of a meeting defined by the primary meeting object to determine that the running time of the meeting is within a threshold time relative to the end time of the secondary meeting object. In response to determining that the running time of the meeting is within a threshold time relative to the end time of the secondary meeting object, displaying a notification on a computing device 11A of the user 10A providing a suggestion of when to leave the meeting.

At operation 814, the system can communicate notifications to other attendees regarding the status of the user with partial attendance. As shown in FIGS. 7A-7F, the system displays indicators showing how soon a user, such as User A having a secondary calendar, will be arriving or leaving meetings defined in a primary calendar. Operation 812 can include method for providing notifications indicating activity of a user 10A having a customized schedule for a meeting. For example, as shown in FIG. 7A, a primary calendar and secondary calendar are accessed during a meeting, the secondary calendar showing that a user has a customized schedule for a meeting.

The system can access a primary calendar 110 comprising a primary meeting object 121A and a secondary calendar 111 comprising a secondary meeting object 122A, the primary meeting object 121A defining a duration of a primary meeting, the secondary meeting object 122A indicating an attendance duration of the user 10A that is less than the duration the primary meeting object 121A. These backend data structures and operations of meeting objects in first and second calendars are utilized to determine when a notification is to be displayed. The time can be a start or end time of the user's shortened schedule. Operation 814 can include monitoring a running time during the primary meeting to determine that the running time of the primary meeting is within a threshold of a time defined in the secondary meeting object 122A, As shown in FIG. 7B or FIG. 7D, the meeting UI displays an indicator next to the user's icon, indicating, such as, how soon the user will be arriving or leaving the meeting. In response to determining that the running time of the primary meeting is within a threshold of the time defined in the secondary meeting object 122A, causing a generation of a notification indicating when the user 10A is arriving or leaving the primary meeting.

FIG. 7B includes an indicator showing when a person is arriving can be countdown timer or a notification or sound. This can include embodiments where the time defined in the secondary meeting object 122A is a start time of the secondary meeting object of when the user is to begin the attendance duration, wherein the start time of the secondary meeting object is after a start time of the primary meeting, wherein the notification is a sound or a graphical element displayed in a status region of a user interface displaying content of the primary meeting.

FIG. 7D includes an indicator showing when a person is leaving, which can be countdown timer or a notification or sound. This can include embodiments where the time defined in the secondary meeting object (122A is an end time of the secondary meeting object of when the user is to end the attendance duration, wherein the end time of the secondary meeting object is before an end time of the primary meeting, wherein the notification is a sound or a graphical element displayed in a status region of a user interface displaying content of the primary meeting.

The system can also automatically control permissions during the transitions between meeting portions using the primary calendar and the secondary calendar. For example, a user may have access to a first set of files shared in a first 1-hour meeting for a first 20-minute block of time of that person's attendance that is defined in the secondary calendar, then the user may have access to a second set of files shared in a second 1-hour meeting that is currently scheduled with the first 1-hour meeting for a second 20-minute block of time of that person's attendance that is defined in the secondary calendar. Using the secondary calendar to control permissions of content in each 1-hour meeting enables the system to maintain a high level of integrity for the primary calendar defining each 1-hour meeting, while also using the secondary calendar to give the system improved security of data by having more granular control to change permissions of files during shorter periods of time.

In the examples disclosed herein, a notification is displayed to instruct a user to leave a meeting or enter another meeting. In some embodiments, the notifications disclosed herein are displayed in conjunction with the system also conducting an automatic transition for the user having a shortened attendance, such as User A. Thus, in some embodiments, the system automatically causes User A to leave a meeting at the end time defined in the secondary calendar. This automatic transition can occur before or after the display of a notification, e.g., when the run time of a meeting meets a threshold.

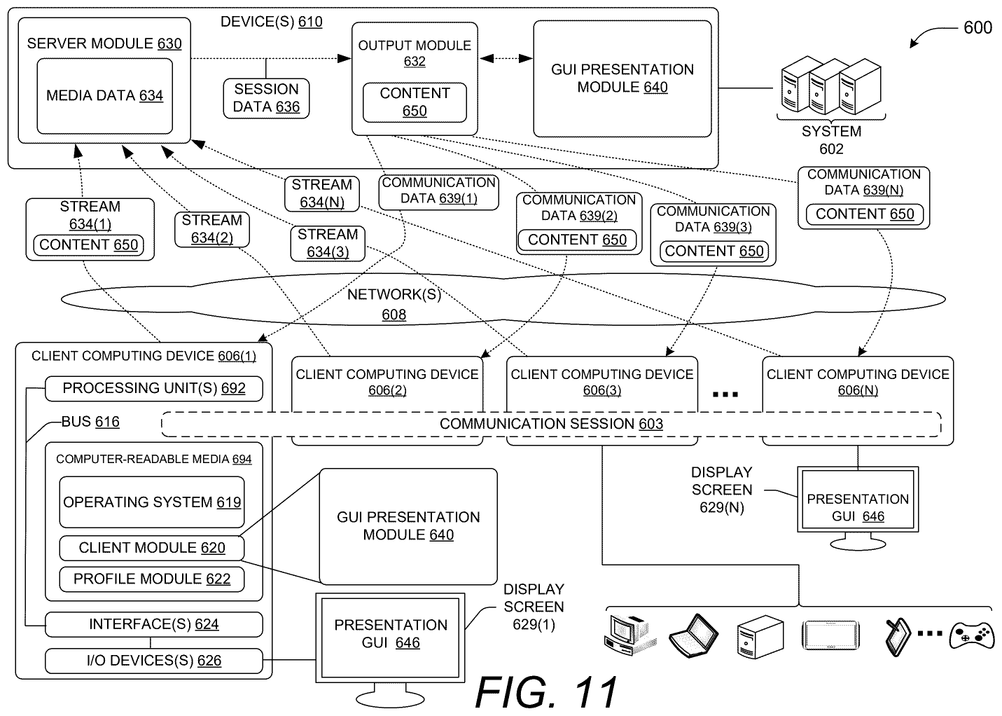

Turning now to FIG. 11, a diagram illustrating an example environment 600 in which a system 602 can implement the disclosed techniques is shown. It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

In some implementations, a system 602 may function to collect, analyze, and share data that is displayed to users of a communication session 603. As illustrated, the communication session 603 may be implemented between a number of client computing devices 606(1) through 606(N) (where N is a number having a value of two or greater) that are associated with or are part of the system 602. The client computing devices 606(1) through 606(N) enable users, also referred to as individuals, to participate in the communication session 603.

In this example, the communication session 603 is hosted, over one or more network(s) 608, by the system 602. That is, the system 602 can provide a service that enables users of the client computing devices 606(1) through 606(N) to participate in the communication session 603 (e.g., via a live viewing and/or a recorded viewing). Consequently, a “participant” to the communication session 603 can comprise a user and/or a client computing device (e.g., multiple users may be in a room participating in a communication session via the use of a single client computing device), each of which can communicate with other participants. As an alternative, the communication session 603 can be hosted by one of the client computing devices 606(1) through 606(N) utilizing peer-to-peer technologies. The system 602 can also host chat conversations and other team collaboration functionality (e.g., as part of an application suite).

In some implementations, such chat conversations and other team collaboration functionality are considered external communication sessions distinct from the communication session 603. A computing system 602 that collects participant data in the communication session 603 may be able to link to such external communication sessions. Therefore, the system may receive information, such as date, time, session particulars, and the like, that enables connectivity to such external communication sessions. In one example, a chat conversation can be conducted in accordance with the communication session 603. Additionally, the system 602 may host the communication session 603, which includes at least a plurality of participants co-located at a meeting location, such as a meeting room or auditorium, or located in disparate locations.

In examples described herein, client computing devices 606(1) through 606(N) participating in the communication session 603 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds can be communicated with the messages.

The system 602 of FIG. 11 includes device(s) 610. The device(s) 610 and/or other components of the system 602 can include distributed computing resources that communicate with one another and/or with the client computing devices 606(1) through 606(N) via the one or more network(s) 608. In some examples, the system 602 may be an independent system that is tasked with managing aspects of one or more communication sessions such as communication session 603. As an example, the system 602 may be managed by entities such as SLACK, WEBEX, GOTOMEETING, GOOGLE HANGOUTS, etc.

Network(s) 608 may include, for example, public networks such as the Internet, private networks such as an institutional and/or personal intranet, or some combination of private and public networks. Network(s) 608 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 608 may utilize communications protocols, including packet-based and/or datagram-based protocols such as Internet protocol (“IP”), transmission control protocol (“TCP”), user datagram protocol (“UDP”), or other types of protocols. Moreover, network(s) 608 may also include a number of devices that facilitate network communications and/or form a hardware basis for the networks, such as switches, routers, gateways, access points, firewalls, base stations, repeaters, backbone devices, and the like.

In some examples, network(s) 608 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11ac and so forth), and other standards.

In various examples, device(s) 610 may include one or more computing devices that operate in a cluster or other grouped configuration to share resources, balance load, increase performance, provide fail-over support or redundancy, or for other purposes. For instance, device(s) 610 may belong to a variety of classes of devices such as traditional server-type devices, desktop computer-type devices, and/or mobile-type devices. Thus, although illustrated as a single type of device or a server-type device, device(s) 610 may include a diverse variety of device types and are not limited to a particular type of device. Device(s) 610 may represent, but are not limited to, server computers, desktop computers, web-server computers, personal computers, mobile computers, laptop computers, tablet computers, or any other sort of computing device.

A client computing device (e.g., one of client computing device(s) 606(1) through 606(N)) (each of which are also referred to herein as a “data processing system”) may belong to a variety of classes of devices, which may be the same as, or different from, device(s) 610, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 606(1) through 606(N) of the various classes and device types can represent any type of computing device having one or more data processing unit(s) 692 operably connected to computer-readable media 694 such as via a bus 616, which in some instances can include one or more of a system bus, a data bus, an address bus, a PCI bus, a Mini-PCI bus, and any variety of local, peripheral, and/or independent buses. Executable instructions stored on computer-readable media 694 may include, for example, an operating system 619, a client module 620, a profile module 622, and other modules, programs, or applications that are loadable and executable by data processing units(s) 692.

Client computing device(s) 606(1) through 606(N) may also include one or more interface(s) 624 to enable communications between client computing device(s) 606(1) through 606(N) and other networked devices, such as device(s) 610, over network(s) 608. Such network interface(s) 624 may include one or more network interface controllers (NICs) or other types of transceiver devices to send and receive communications and/or data over a network. Moreover, client computing device(s) 606(1) through 606(N) can include input/output (“I/O”) interfaces (devices) 626 that enable communications with input/output devices such as user input devices including peripheral input devices (e.g., a game controller, a keyboard, a mouse, a pen, a voice input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 11 illustrates that client computing device 606(1) is in some way connected to a display device (e.g., a display screen 629(N)), which can display a UI according to the techniques described herein.

In the example environment 600 of FIG. 11, client computing devices 606(1) through 606(N) may use their respective client modules 620 to connect with one another and/or other external device(s) in order to participate in the communication session 603, or in order to contribute activity to a collaboration environment. For instance, a first user may utilize a client computing device 606(1) to communicate with a second user of another client computing device 606(2). When executing client modules 620, the users may share data, which may cause the client computing device 606(1) to connect to the system 602 and/or the other client computing devices 606(2) through 606(N) over the network(s) 608.

The client computing device(s) 606(1) through 606(N) may use their respective profile modules 622 to generate participant profiles (not shown in FIG. 11) and provide the participant profiles to other client computing devices and/or to the device(s) 610 of the system 602. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 11, the device(s) 610 of the system 602 include a server module 630 and an output module 632. In this example, the server module 630 is configured to receive, from individual client computing devices such as client computing devices 606(1) through 606(N), media streams 634(1) through 634(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 630 is configured to receive a collection of various media streams 634(1) through 634(N) during a live viewing of the communication session 603 (the collection being referred to herein as “media data 634”). In some scenarios, not all of the client computing devices that participate in the communication session 603 provide a media stream. For example, a client computing device may only be a consuming, or a “listening”, device such that it only receives content associated with the communication session 603 but does not provide any content to the communication session 603.

In various examples, the server module 630 can select aspects of the media streams 634 that are to be shared with individual ones of the participating client computing devices 606(1) through 606(N). Consequently, the server module 630 may be configured to generate session data 636 based on the streams 634 and/or pass the session data 636 to the output module 632. Then, the output module 632 may communicate communication data 639 to the client computing devices (e.g., client computing devices 606(1) through 606(3) participating in a live viewing of the communication session). The communication data 639 may include video, audio, and/or other content data, provided by the output module 632 based on content 650 associated with the output module 632 and based on received session data 636. The content 650 can include the streams 634 or other shared data, such as an image file, a spreadsheet file, a slide deck, a document, etc. The streams 634 can include a video component depicting images captured by an I/O device 626 on each client computer. The content 650 also include input data from each user, which can be used to control a direction and location of a representation. The content can also include instructions for sharing data and identifiers for recipients of the shared data. Thus, the content 650 is also referred to herein as input data 650 or an input 650.

As shown, the output module 632 transmits communication data 639(1) to client computing device 606(1), and transmits communication data 639(2) to client computing device 606(2), and transmits communication data 639(3) to client computing device 606(3), etc. The communication data 639 transmitted to the client computing devices can be the same or can be different (e.g., positioning of streams of content within a user interface may vary from one device to the next).

In various implementations, the device(s) 610 and/or the client module 620 can include GUI presentation module 640. The GUI presentation module 640 may be configured to analyze communication data 639 that is for delivery to one or more of the client computing devices 606. Specifically, the UI presentation module 640, at the device(s) 610 and/or the client computing device 606, may analyze communication data 639 to determine an appropriate manner for displaying video, image, and/or content on the display screen 629 of an associated client computing device 606. In some implementations, the GUI presentation module 640 may provide video, image, and/or content to a presentation GUI 646 rendered on the display screen 629 of the associated client computing device 606. The presentation GUI 646 may be caused to be rendered on the display screen 629 by the GUI presentation module 640. The presentation GUI 646 may include the video, image, and/or content analyzed by the GUI presentation module 640.

In some implementations, the presentation GUI 646 may include a plurality of sections or grids that may render or comprise video, image, and/or content for display on the display screen 629. For example, a first section of the presentation GUI 646 may include a video feed of a presenter or individual, a second section of the presentation GUI 646 may include a video feed of an individual consuming meeting information provided by the presenter or individual. The GUI presentation module 640 may populate the first and second sections of the presentation GUI 646 in a manner that properly imitates an environment experience that the presenter and the individual may be sharing.

In some implementations, the GUI presentation module 640 may enlarge or provide a zoomed view of the individual represented by the video feed in order to highlight a reaction, such as a facial feature, the individual had to the presenter. In some implementations, the presentation GUI 646 may include a video feed of a plurality of participants associated with a meeting, such as a general communication session. In other implementations, the presentation GUI 646 may be associated with a channel, such as a chat channel, enterprise Teams channel, or the like. Therefore, the presentation GUI 646 may be associated with an external communication session that is different from the general communication session.

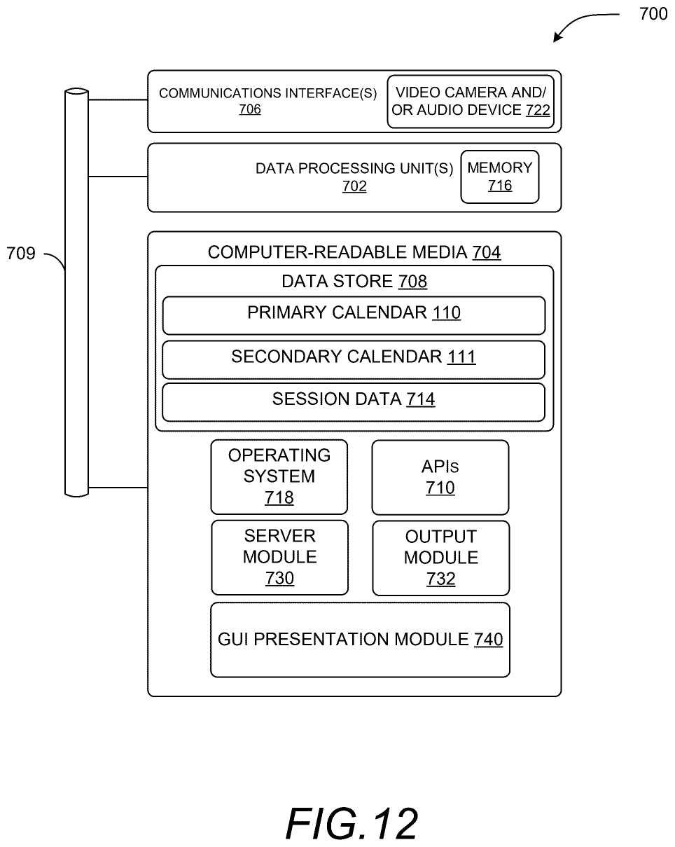

FIG. 12 illustrates a diagram that shows example components of an example device 700 (also referred to herein as a “computing device”) configured to generate data for some of the user interfaces disclosed herein. The device 700 may generate data that may include one or more sections that may render or comprise video, images, virtual objects, and/or content for display on the display screen 629. The device 700 may represent one of the device(s) described herein. Additionally, or alternatively, the device 700 may represent one of the client computing devices 606.

As illustrated, the device 700 includes one or more data processing unit(s) 702, computer-readable media 704, and communication interface(s) 706. The components of the device 700 are operatively connected, for example, via a bus 709, which may include one or more of a system bus, a data bus, an address bus, a PCI bus, a Mini-PCI bus, and any variety of local, peripheral, and/or independent buses.

As utilized herein, data processing unit(s), such as the data processing unit(s) 702 and/or data processing unit(s) 692, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 704 and computer-readable media 694, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which might also be referred to herein as a computer-readable medium, may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device. The computer storage media can also be referred to herein as computer-readable storage media, non-transitory computer-readable storage media, non-transitory computer-readable medium, computer-readable storage medium, computer-readable storage device, or computer storage medium.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 706 may represent, for example, network interface controllers (“NICs”) or other types of transceiver devices to send and receive communications over a network. Furthermore, the communication interface(s) 706 may include one or more video cameras and/or audio devices 722 to enable generation of video feeds and/or still images, and so forth.

In the illustrated example, computer-readable media 704 includes a data store 708. In some examples, the data store 708 includes data storage such as a database, data warehouse, or other type of structured or unstructured data storage. In some examples, the data store 708 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 708 may store data for the operations of processes, applications, components, and/or modules stored in computer-readable media 704 and/or executed by data processing unit(s) 702 and/or accelerator(s). For instance, in some examples, the data store 708 may store the primary calendar and secondary calendar, and other session data that show the status and activity level of each user. The session data can include a total number of participants (e.g., users and/or client computing devices) in a communication session, activity that occurs in the communication session, a list of invitees to the communication session, and/or other data related to when and how the communication session is conducted or hosted. The data store 708 may also include session data 714, such as the content that includes video, audio, or other content that can be shared in a meeting. The session data can also include permissions for each user. For example, session data can indicate that past meetings included users having speaker roles and other roles. This data can also indicate preferences, e.g., that a user wants to join meetings with video broadcasting turned on and preferences to indicate that they wish to prioritize meetings that lists them as a presenter as a high priority meeting. In another example, a role of a designated presenter can be granted to some users and other users can have an audience role.

Alternately, some or all of the above-referenced data can be stored on separate memories 716 on board one or more data processing unit(s) 702 such as a memory on board a CPU-type processor, a GPU-type processor, an FPGA-type accelerator, a DSP-type accelerator, and/or another accelerator. In this example, the computer-readable media 704 also includes an operating system 718 and application programming interface(s) 710 (APIs) configured to expose the functionality and the data of the device 700 to other devices. Additionally, the computer-readable media 704 includes one or more modules such as the server module 730, the output module 732, and the GUI presentation module 740, although the number of illustrated modules is just an example, and the number may vary. That is, functionality described herein in association with the illustrated modules may be performed by a fewer number of modules or a larger number of modules on one device or spread across multiple devices.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method, executed by a data processing system, for providing notifications indicating activity of a user having a customized schedule for a meeting, the method comprising:
accessing a primary calendar comprising a primary meeting object and a secondary calendar comprising a secondary meeting object, the primary meeting object defining a duration of a primary meeting, the secondary meeting object indicating an attendance duration of the user that is less than the duration the primary meeting object;
monitoring a running time during the primary meeting to determine that the running time of the primary meeting is within a threshold of a time defined in the secondary meeting object; and
in response to determining that the running time of the primary meeting is within a threshold of the time defined in the secondary meeting object, causing a generation of a notification indicating when the user is arriving or leaving the primary meeting.

2. The method of claim 1, wherein the time defined in the secondary meeting object is a start time of the secondary meeting object of when the user is to begin the attendance duration, wherein the start time of the secondary meeting object is after a start time of the primary meeting, wherein the notification is a sound or a graphical element displayed in a status region of a user interface displaying content of the primary meeting.

3. The method of claim 2, wherein the method further comprises: updating the graphical element with a countdown timer showing a time difference between the running time of the primary meeting and start time of the secondary meeting object.

4. The method of claim 1, wherein the time defined in the secondary meeting object is an end time of the secondary meeting object of when the user is to end the attendance duration, wherein the end time of the secondary meeting object is before an end time of the primary meeting, wherein the notification is a sound or a graphical element displayed in a status region of a user interface displaying content of the primary meeting.

5. The method of claim 4, wherein the method further comprises: updating the graphical element with a countdown timer showing a time difference between the running time of the primary meeting and end time of the secondary meeting object.

6. The method of claim 1, wherein the time defined in the secondary meeting object is a start time of the secondary meeting object of when the user is to begin the attendance duration, wherein the running time of the primary meeting is within the threshold of the time of the secondary meeting object when the running time has reached the start time of the secondary meeting object, wherein the notification is a sound or a graphical element displayed in a status region of a user interface displaying content of the primary meeting.

7. The method of claim 1, wherein the time defined in the secondary meeting object is an end time of the secondary meeting object of when the user is to end the attendance duration, wherein the running time of the primary meeting is within the threshold of the time of the secondary meeting object when the running time has reached the end time of the secondary meeting object, wherein the notification is a sound or a graphical element displayed in a status region of a user interface displaying content of the primary meeting.

8. A system providing notifications indicating activity of a user having a customized schedule for a meeting, comprising:
one or more processing units; and
a computer-readable storage medium having encoded thereon computer-executable instructions to cause the one or more processing units to:
access a primary calendar comprising a primary meeting object and a secondary calendar comprising a secondary meeting object, the primary meeting object defining a duration of a primary meeting, the secondary meeting object indicating an attendance duration of the user that is less than the duration the primary meeting object;
monitor a running time during the primary meeting to determine that the running time of the primary meeting is within a threshold of a time defined in the secondary meeting object; and
in response to determining that the running time of the primary meeting is within a threshold of the time defined in the secondary meeting object, cause a generation of a notification indicating when the user is arriving or leaving the primary meeting.

9. The system of claim 8, wherein the time defined in the secondary meeting object is a start time of the secondary meeting object of when the user is to begin the attendance duration, wherein the start time of the secondary meeting object is after a start time of the primary meeting, wherein the notification is a sound or a graphical element displayed in a status region of a user interface displaying content of the primary meeting.

10. The system of claim 9, wherein the instructions further cause the one or more processing units to: update the graphical element with a countdown timer showing a time difference between the running time of the primary meeting and start time of the secondary meeting object.

11. The system of claim 8, wherein the time defined in the secondary meeting object is an end time of the secondary meeting object of when the user is to end the attendance duration, wherein the end time of the secondary meeting object is before an end time of the primary meeting, wherein the notification is a sound or a graphical element displayed in a status region of a user interface displaying content of the primary meeting.

12. The system of claim 11, wherein the instructions further cause the one or more processing units to: update the graphical element with a countdown timer showing a time difference between the running time of the primary meeting and end time of the secondary meeting object.

13. The system of claim 8, wherein the time defined in the secondary meeting object is a start time of the secondary meeting object of when the user is to begin the attendance duration, wherein the running time of the primary meeting is within the threshold of the time of the secondary meeting object when the running time has reached the start time of the secondary meeting object, wherein the notification is a sound or a graphical element displayed in a status region of a user interface displaying content of the primary meeting.

14. The system of claim 8, wherein the time defined in the secondary meeting object is an end time of the secondary meeting object of when the user is to end the attendance duration, wherein the running time of the primary meeting is within the threshold of the time of the secondary meeting object when the running time has reached the end time of the secondary meeting object, wherein the notification is a sound or a graphical element displayed in a status region of a user interface displaying content of the primary meeting.

15. A computer-readable storage medium having encoded thereon computer-executable instructions to cause the one or more processing units of a system to:
access a primary calendar comprising a primary meeting object and a secondary calendar comprising a secondary meeting object, the primary meeting object defining a duration of a primary meeting, the secondary meeting object indicating an attendance duration of a user that is less than the duration the primary meeting object;
monitor a running time during the primary meeting to determine that the running time of the primary meeting is within a threshold of a time defined in the secondary meeting object; and
in response to determining that the running time of the primary meeting is within a threshold of the time defined in the secondary meeting object, cause a generation of a notification indicating when the user is arriving or leaving the primary meeting.

16. The computer-readable storage medium of claim 15, wherein the time defined in the secondary meeting object is a start time of the secondary meeting object of when the user is to begin the attendance duration, wherein the start time of the secondary meeting object is after a start time of the primary meeting, wherein the notification is a sound or a graphical element displayed in a status region of a user interface displaying content of the primary meeting.

17. The syst computer-readable storage medium of claim 16, wherein the instructions further cause the one or more processing units to: update the graphical element with a countdown timer showing a time difference between the running time of the primary meeting and start time of the secondary meeting object.

18. The computer-readable storage medium of claim 15, wherein the time defined in the secondary meeting object is an end time of the secondary meeting object of when the user is to end the attendance duration, wherein the end time of the secondary meeting object is before an end time of the primary meeting, wherein the notification is a sound or a graphical element displayed in a status region of a user interface displaying content of the primary meeting.

19. The computer-readable storage medium of claim 18, wherein the instructions further cause the one or more processing units to: update the graphical element with a countdown timer showing a time difference between the running time of the primary meeting and end time of the secondary meeting object.

20. The computer-readable storage medium of claim 15, wherein the time defined in the secondary meeting object is a start time of the secondary meeting object of when the user is to begin the attendance duration, wherein the running time of the primary meeting is within the threshold of the time of the secondary meeting object when the running time has reached the start time of the secondary meeting object, wherein the notification is a sound or a graphical element displayed in a status region of a user interface displaying content of the primary meeting.
